(19) United States
(12) Patent Application Publication
(10) Pub. No.: US 2025/0307666 A1
(43) Pub. Date: Oct. 2, 2025

(54) INFORMATION PROCESSING

(71) Applicant: Beijing Zitiao Network Technology Co., Ltd., Beijing (CN)

(72) Inventor: Yuanxi Zhang, Beijing (CN)

(21) Appl. No.: 18/985,952

(22) Filed: Dec. 18, 2024

(30) Foreign Application Priority Data
Mar. 28, 2024 (CN) 202410371110.2
Nov. 29, 2024 (CN) 202411748663.1

(51) Int. Cl. G06N 5/022; G06F 3/04847

(52) U.S. Cl. CPC G06N 5/022; G06F 3/04847

(57) ABSTRACT

Embodiments relate to information processing, including: in response to receiving a creation request, presenting a configuration page for receiving configuration information of a knowledge base, the configuration page comprising: a first configuration area to receive a configuration of a target type of the knowledge base from a plurality of data types, and a second configuration area to receive a configuration of a target data source of the knowledge base; in response to receiving the configurations of the target type and the target data source, importing data of the target type from the target data source into the knowledge base; in response to completing the importing the data, presenting an index settings page corresponding to the target type to receive index settings information for the imported data; and in response to receiving the index settings information, creating the knowledge base of the target type based on the index settings information.

### CROSS-REFERENCE TO RELATED APPLICATION(S)

This application claims priority to Chinese Patent Application No. 202410371110.2, filed on Mar. 28, 2024, and entitled “METHOD, APPARATUS, DEVICE, AND STORAGE MEDIUM FOR INFORMATION PROCESSING” and Chinese Patent Application No. 202411748663.1, filed on Nov. 29, 2024, and entitled “METHOD, APPARATUS, DEVICE, AND STORAGE MEDIUM FOR INFORMATION PROCESSING”, the entireties of which are incorporated herein by reference.

### FIELD

Example embodiments of the present specification relate generally to the field of computers and, more particularly, to information processing.

### BACKGROUND

In recent years, with the rapid development of artificial intelligence, the creation and use of knowledge bases have become more and more widespread. Knowledge bases can reserve specialized knowledge or content in related fields for people to quickly access the information they need. However, the existing ways of creation and invocation of knowledge bases are still unsatisfactory and may affect the creation efficiency as well as the access efficiency to information.

### SUMMARY

In a first aspect of the present disclosure, a method of information processing is provided. The method includes: in response to receiving a creation request, presenting a configuration page for receiving configuration information of a knowledge base, the configuration page including: a first configuration area to receive a configuration of a target type of the knowledge base from a plurality of data types, and a second configuration area to receive a configuration of a target data source of the knowledge base; in response to receiving the configurations of the target type and the target data source, importing data of the target type from the target data source into the knowledge base; in response to completing the importing the data, presenting an index settings page corresponding to the target type to receive index settings information for the imported data; and in response to receiving the index settings information, creating the knowledge base of the target type based on the index settings information.

In a second aspect of the present disclosure, an apparatus for information processing is provided. The apparatus includes: a display module configured to, in response to receiving a creation request, present a configuration page for receiving configuration information of a knowledge base, the configuration page including: a first configuration area to receive a configuration of a target type of the knowledge base from a plurality of data types, and a second configuration area to receive a configuration of a target data source of the knowledge base; an import module configured to, in response to receiving the configurations of the target type and the target data source, import data of the target type from the target data source into the knowledge base; a settings module configured to, in response to completing the importing the data, present an index settings page corresponding to the target type to receive index settings information for the imported data; and a creation module configured to, in response to receiving the index settings information, create the knowledge base of the target type based on the index settings information.

In a third aspect of the present disclosure, an electronic device is provided. The electronic device includes: at least one processing unit; and at least one memory coupled to the at least one processing unit and storing instructions for execution by the at least one processing unit, the instructions, when executed by the at least one processing unit, causing the electronic device to perform operations that implement the method of the first aspect.

In a fourth aspect of the present disclosure, a computer-readable storage medium having a computer program stored thereon, the computer program being executable by a processor to perform operations that implement the method of the first aspect.

In a fifth aspect of the present disclosure, a computer program product being tangibly stored in a computer storage medium and including computer-executable instructions which, when executed by a device, cause the device to perform operations that implement the method of the first aspect.

It would be appreciated that the content described in the section is neither intended to identify the key features or essential features of the present disclosure, nor is it intended to limit the scope of the present disclosure. Other features of the present disclosure will be readily understood through the following description.

### BRIEF DESCRIPTION OF THE DRAWINGS

The above and other features, advantages and aspects of the various embodiments of the present disclosure will become more apparent in combination with the accompanying drawings and with reference to the following detailed description. In the drawings, the same or similar reference symbols refer to the same or similar elements, wherein:

FIG. 1 illustrates a schematic diagram of an example environment.

FIG. 2 illustrates a schematic diagram of a knowledge base architecture.

FIG. 3 illustrates a flowchart of an example process for data processing.

FIGS. 4A to 4E illustrate examples of pages for creating a knowledge base of a document type.

FIGS. 5A to 5G illustrate examples of pages for creating a knowledge base of an image type.

FIG. 6 illustrates an example of a page for viewing a list of knowledge bases.

FIGS. 7A to 7F illustrate examples of pages for managing a knowledge base of a document type.

FIGS. 8A to 8C illustrate examples of pages for managing a knowledge base of an image type.

FIG. 9 illustrates an example of a page for configuring a knowledge base in a third-party application.

FIG. 10 illustrates a flowchart of an example process of adding table type data.

FIG. 11 illustrates a flowchart of an example process of retrieving data of a knowledge base based on hybrid searching.

FIG. 12 illustrates an example of a page for knowledge base application settings.

FIGS. 13A and 13B illustrate flowcharts of example processes of retrieving data of a knowledge base of an image type.

FIG. 14 illustrates a flowchart of an example process for information processing.

FIG. 15 illustrates a schematic structural block diagram of an example apparatus for information processing.

FIG. 16 illustrates a block diagram of an example electronic device.

### DETAILED DESCRIPTION

The embodiments of the present disclosure will be described in more detail below with reference to the accompanying drawings. Although certain embodiments of the present disclosure are shown in the drawings, it would be appreciated that the present disclosure can be implemented in various forms and should not be interpreted as limited to the embodiments described in this specification. On the contrary, these embodiments are provided for a more thorough and complete understanding of the present disclosure. It would be appreciated that the accompanying drawings and embodiments of the present disclosure are only for the purpose of illustration and are not intended to limit the scope of protection of the present disclosure.

It should be noted that the titles of any section/subsection provided herein are not restrictive. Various embodiments are described throughout the specification, and any type of embodiment may be included under any section/subsection. In addition, the embodiments described in any section/subsection may be combined in any way with any other embodiments described in the same section/subsection and/or different sections/subsections.

In the description of the embodiments of the present disclosure, the term “including”, and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. The terms “first”, “second”, etc. may refer to different or identical objects. The following may also include other explicit and implicit definitions.

Unless expressly stated in this specification, performing a step “in response to A” does not mean that the step is performed immediately after “A”, but may include one or more intermediate steps.

It will be appreciated that the data involved in this technical solution (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, wherein the relevant user may include any type of rights subject, such as individuals, enterprises, groups.

For example, in response to receiving an active request from a user, a prompt message is sent to the user to explicitly prompt the user that the operation requested operation by the user will need to obtain and use personal information of the user, so that users may select whether to provide personal information to the software or the hardware such as an electronic device, an application, a server or a storage medium that perform the operation of the technical solution of the present disclosure according to the prompt information.

As an optional but non-restrictive implementation, in response to receiving an active request of the user, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization processes are only schematic and do not limit the implementations of the present disclosure. Other methods that meet relevant laws and regulations may also be applied to the implementation of the present disclosure.

As used in this specification, the term “model” can learn a correlation between respective inputs and outputs from training data, so that a corresponding output can be generated for a given input after training is completed. The generation of the model can be based on machine learning techniques. Deep learning is a machine learning algorithm that processes inputs and provides corresponding outputs by using multiple layers of processing units. A neural networks model is an example of a deep learning-based model. As used in this specification, “model” may also be referred to as “machine learning model”, “learning model”, “machine learning network”, or “learning network”, and these terms are used interchangeably.

As mentioned above, with the rapid development of artificial intelligence, the creation and use of knowledge bases have become more and more widespread. Knowledge bases can reserve specialized knowledge or content in related fields for people to quickly access the information they need through knowledge bases. However, existing methods of creation and invocation of the knowledge bases are limited, which greatly affects the efficiency of creating the knowledge bases and obtaining the information.

Some embodiments of the present disclosure propose solutions for creating, managing, and applying a knowledge base. One such solution may include: in response to receiving a creation request, presenting a configuration page for receiving configuration information of a knowledge base, the configuration page including a first configuration area to receive a configuration of a target type of the knowledge base from a plurality of data types, and a second configuration area to receive a configuration of a target data source of the knowledge base. In response to receiving the configurations of the target type and the target data source, data of the target type is imported from the target data source into the knowledge base. In response to a completion of importing the data, an index settings page corresponding to the target type is presented, to receive index settings information for the imported data. In response to receiving the index settings information, the imported data is processed to create the knowledge base of the target type based on the index settings information, the created knowledge base including a plurality of data items indexable after the processing.

In this way, it is possible to support a user in creating a specific type of knowledge base as needed, and guide the user based on the type of knowledge base to configure information required for the knowledge base, thereby improving the efficiency of creating the knowledge base and the flexibility in the subsequent use of the knowledge base. In addition, some embodiments of the present disclosure may provide a solution for the creation of the knowledge base that is modular, simple, and free to select data, thus allowing the user to conveniently and quickly create knowledge bases that are easy to index the data, while facilitating the user in obtaining the required information from the knowledge bases.

Various example implementations of the solution are further described in detail below in conjunction with the accompanying drawings.

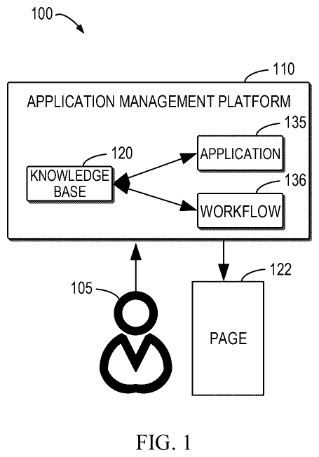

FIG. 1 illustrates a schematic diagram of an example environment 100 in which embodiments of the present disclosure can be implemented. As shown in FIG. 1, an application management platform 110 may provide the user 105 with an environment for creating, managing, and releasing knowledge bases, datasets, various types of applications, workflows, and the like. The application management platform 110 may be any suitable platform that supports the development of knowledge bases, various types of applications, workflows, and the like by the user. In some embodiments, the application management platform 110 may be a low-code platform that provides an ensemble of tools for knowledge base creation. The application management platform 110 can support the visual development of knowledge bases, applications, and workflows, thereby allowing developers to skip the process of manual coding and speed up the development cycle. Such a platform can support efficient development by users, enabling operations such as application creation and application functionality adjustment.

The application management platform 110 can be deployed locally on a terminal device of the user 105 and/or can be supported by a remote server. For example, a client with the application management platform 110 may be run on the terminal device of the user 105, which can support the interaction of the user with the application management platform 110. In the case where the application management platform 110 is run locally on the terminal device of the user, the user 105 can directly use the client to interact with the local application management platform 110. In the case where the application management platform 110 is run on a server level device, the server-side device can implement the provision of services to the client running on the terminal device based on the communication connection between the terminal device. The application management platform 110 can present a corresponding page 122 to the user 105 based on the operation of the user 105 to output and/or receive information from the user 105.

In some embodiments, the application management platform 110 may be associated with a corresponding database, which stores data or information required for the digital application management process supported by the application management platform 110. For example, the database may store code and description information corresponding to various functional modules that make up the knowledge base. The application management platform 110 may also perform operations such as calling, adding, deleting, updating, etc. on the functional modules in the database. The database may also store operations that can be performed on different functional blocks. For example, in a scenario where a knowledge base is to be created, the application management platform 110 may call corresponding functional blocks from the database to build the knowledge base.

In embodiments of the present disclosure, the user 105 can create a knowledge base 120 and release it as needed on the application management platform 110. The knowledge base 120 may be released to any appropriate platforms, as long as these platforms can support access to the knowledge base.

After release, the knowledge base 120 may be associated with one or more applications 135 or workflows 136. The applications 135 or workflows 136 may rely on the knowledge in the knowledge base 120 to determine a response to a query from the user. In some embodiments, the applications 135 may include a digital assistant. The knowledge base 120 may be configured for the digital assistant. The digital assistant may interact and converse with the user 105 based on the content in the knowledge base 120. The interaction message between the user 105 and the digital assistant may include a multimodal form of message, such as a text message (e.g., natural language text), a speech message, an image message, a video message, and the like.

The application management platform 110 may be run on an appropriate electronic device. The electronic device in this specification may be any suitable type of computing-capable device, including a terminal device or a server-side device. The terminal device may be any type of mobile terminal device, fixed terminal device, or portable terminal device, including mobile phones, desktop computers, laptop computers, notebook computers, netbook computers, tablet computers, media computers, multimedia tablets, personal communication system (PCS) devices, personal navigation devices, personal digital assistants (PDAs), audio/mobile player, digital cameras/video cameras, positioning devices, television receivers, radio broadcast receivers, e-book devices, gaming devices, or any combination thereof, including accessories and peripherals of these devices, or any combination thereof. Server-side devices may include, for example, computing systems/servers, such as mainframes, edge computing nodes, computing devices in cloud environments, and so on. In some embodiments, the application management platform 110 may be implemented based on cloud service.

It should be understood that the structure and function of the environment 100 are described only for illustrative purposes and do not imply any limitation on the scope of the present disclosure. For example, although FIG. 1 illustrates a single user interacting with the application management platform 110, multiple users may actually access the application management platform 110 to create knowledge bases, develop applications, workflows, and so on.

Some example embodiments of the present disclosure will be described in detail below with reference to the examples of the accompanying drawings. It should be understood that the pages illustrated in the accompanying drawings are merely examples and that various page designs may actually exist. Individual graphical elements on the page may have different arrangements and different visual redisplays, one or more of the elements may be omitted or replaced, and one or more other elements may be present. Embodiments of the present disclosure are not limited in this regard.

The knowledge base creation process described in embodiments of the present disclosure may be implemented in a knowledge base creation platform, a terminal device on which the knowledge base creation platform is installed, and/or a server corresponding to the knowledge base creation platform. In the following examples, for the sake of discussion, the knowledge base creation platform is described from the perspective of a knowledge base creation platform, such as the application management platform 110 shown in FIG. 1. A page presented by the application management platform 110 may be presented via a terminal device of the user 105, and user input may be received via the terminal device of the user 105. Throughout this specification, the user 105 who creates the knowledge base is sometimes referred to as a knowledge base creator, a knowledge base developer, and the like.

The user 105 may initiate a creation request to the application management platform 110 as needed. In response to receiving a creation request, the application management platform 110 presents a page for creating a knowledge base. The user 105 may configure the knowledge base to be created (assuming it is the knowledge base 120 shown in FIG. 1) on the page. Unlike creating a knowledge base by means of coding, in the embodiments of the present disclosure, the page for creating a knowledge base is designed to include at least one configuration area that receives configuration information of the knowledge base, and each configuration area is defined as receiving a type of configuration information required to build the knowledge base.

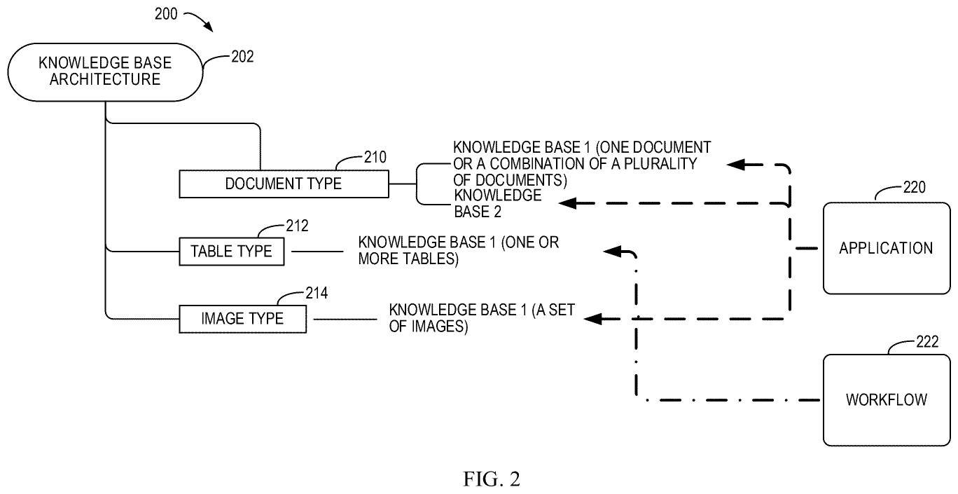

FIG. 2 illustrates a schematic diagram of a knowledge base architecture according to some embodiments of the present disclosure. As shown in the schematic diagram 200 of the knowledge base architecture in FIG. 2, knowledge base architecture 202 may be composed of various types of data. For example, the types of the knowledge base architecture 202 may include a document type 210, a table type 212, and an image type 214. The user 105 may create at least one knowledge base 120 of the corresponding type based on the knowledge base architecture 202. For example, for a knowledge base of the document type 210, the user 105 may establish one or more knowledge bases (knowledge base 1, knowledge base 2) of the document type 210 as needed. Each knowledge base of the document type may include one document or a combination of a plurality of documents. Similarly, the user 105 may also create one or more corresponding knowledge bases for the table type 212 and the image type 214. It can be understood that the knowledge base 120 of the document type 210 may include data of the document type 210, the knowledge base 120 of the table type 212 may include data of the table type 212, and the knowledge base 120 of the image type 214 may include data of the image type 214.

In some embodiments, still referring to FIG. 2, the application or workflow may be associated with the at least one knowledge base 120. Further, the application or workflow may invoke data from the at least one knowledge base 120 associated therewith during use. As an example, as shown in FIG. 2, the application 220 is associated with two knowledge bases of the document type 210 and the knowledge base 120 of an image type 214, then the application may retrieve document data in the knowledge base 120 of the two document types 210 and image data in the knowledge base 120 of an image type 214 during use. The workflow 222 is associated with the knowledge base 120 of the table type 212, then the workflow 222 can retrieve the table data in the knowledge base of that table type 212. The application mentioned herein may be implemented as a digital assistant, any database with question and answer functionality or knowledge retrieval functionality. The workflow mentioned herein may be configured to automate specific tasks.

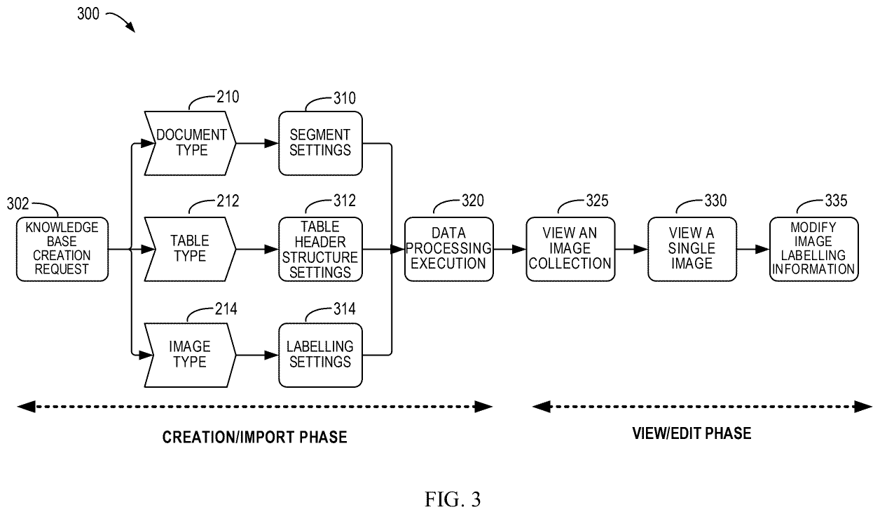

FIG. 3 illustrates a flowchart of an example process 300 for knowledge base management according to some embodiments of the present disclosure. The process 300 for knowledge base management may be implemented at the application management platform 110 as described before. The process 300 is described below with reference to FIG. 1.

As shown in FIG. 3, a management cycle of the knowledge base may be divided into a creation/import phase and a view/edit phase.

During the creation/import phase, at block 302, the application management platform 110 may receive a knowledge base creation request.

In response to receiving the knowledge base creation request, the application management platform 110 may provide a user with selectable types of knowledge bases for selection. The selectable types of knowledge bases include the document type 210, the table type 212, and the image type 214. It can be understood that according to actual application requirements, more, less, or different types of data may be configured or supported, including, for example, a video type, a Mind Map type, and so on.

If it is determined that the user selects the document type 210, at block 310, the application management platform 110 may present a corresponding page to the user and receive segment settings corresponding to the document type from the user.

If it is determined that the user selects the table type 212, at block 312, the application management platform 110 may present a corresponding page to the user and receive the header structure settings corresponding to the table type from the user.

If it is determined that the user selects the image type 214, at block 314, the application management platform 110 may present a corresponding page to the user and receive labeling settings corresponding to the image type from the user.

After the execution at block 310, block 312, or block 314, at block 320, the application management platform 110 may perform data processing execution to implement import and processing of the data, to complete the creation of the knowledge base.

After the knowledge base is created, it may also be associated with one or more applications (e.g., a digital assistant application, question-answering application, etc.) or workflows (which, for example, perform data queries that rely on the knowledge). If the knowledge base is associated with an application or workflow, the knowledge base may be invoked to process query information for the associated application or workflow. The invocation to the knowledge base is selectable, which may be determined based on the query information to decide whether the associated knowledge base is to be invoked to assist the processing of the current query information. The data stored in this knowledge base may be queried to determine the response to the query information.

After the creation of the knowledge base, it may be viewed or edited. Viewing or editing of the data in the knowledge base 120 may be supported in the view/edit phase. For clarity, the view/edit phase is described with respect to an image type knowledge base. At block 325, the application management platform 110 may view an image collection.

At block 330, the application management platform 110 may view a single image from the image collection.

At block 335, the application management platform 110 may modify image labeling information.

Detailed steps in the specific data processing can be described with reference to the embodiments in the following.

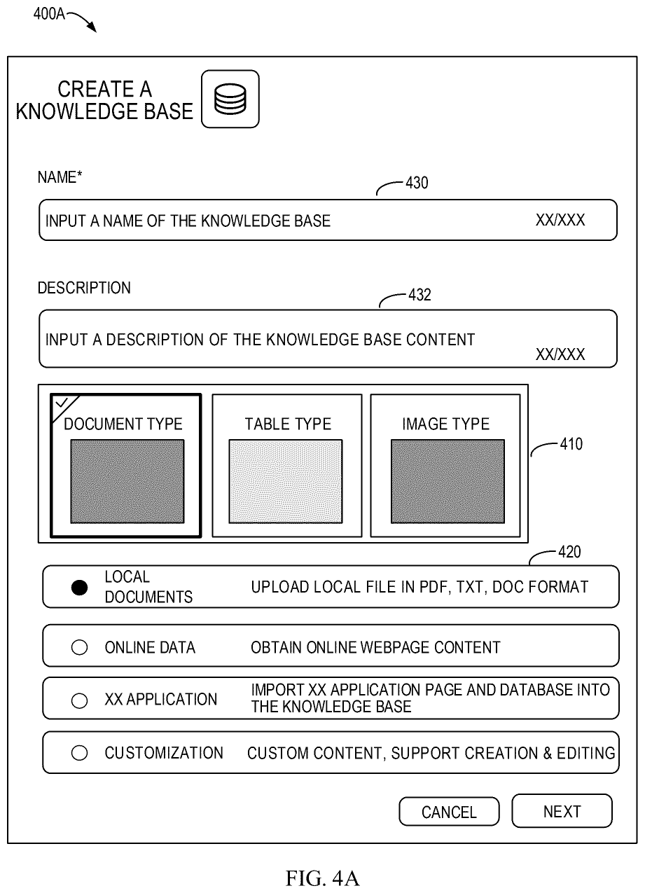

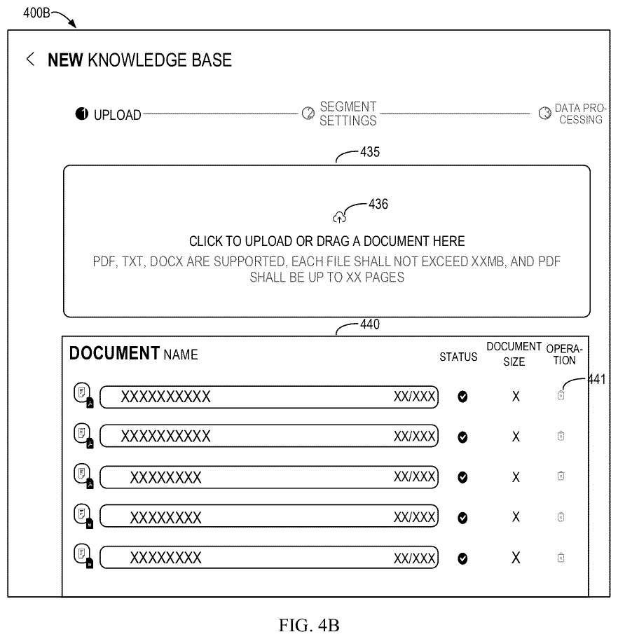

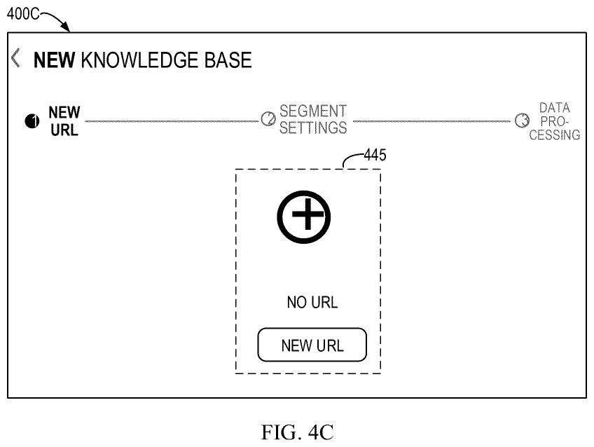

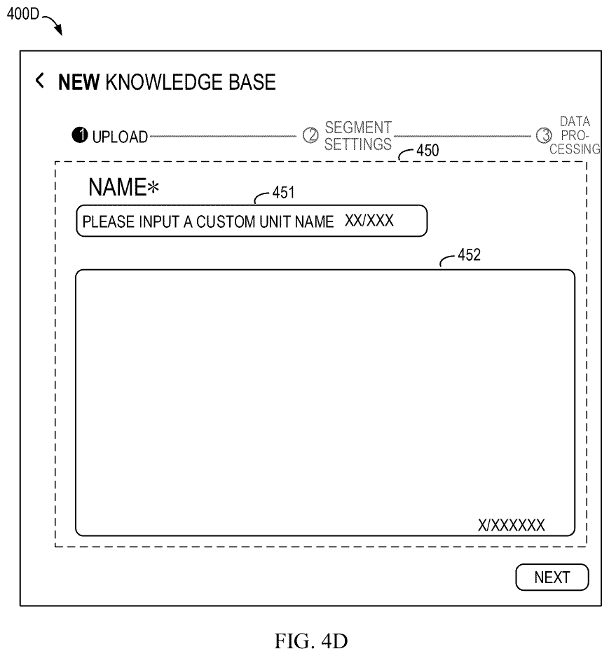

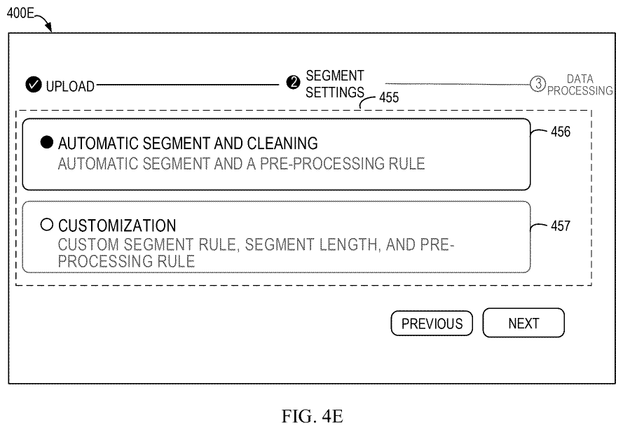

FIGS. 4A to 4E illustrate examples of pages 400A to 400E for creating a knowledge base of a document type according to some embodiments of the present disclosure. The pages 400A to 400E may be provided, for example, by the application management platform 110 shown in FIG. 1.

Specifically, the page includes at least a first configuration area to receive a configuration of a target type of the knowledge base 120 from a plurality of data types. For example, page 400A of FIG. 4A (which may also be referred to as knowledge base creation page 400A) provides a first configuration area 410 that includes three type selection blocks, each of which corresponds to a document type, a table type, and an image type, respectively, and a type selection block that selects a document type indicates that the target type received for configuration of the knowledge base 120 is a document type.

The received target type configured for the knowledge base 120 as part of the configuration information for the knowledge base 120 will limit the type of data supported by that knowledge base 120 to the target type and exclude other types of data. The knowledge base 120 can only store data of the target type, i.e., the knowledge base 120 created in this specification is a specialized database that only supports the target type.

By providing a specific visual configuration area during the creation process to allow the user to select the target type, this allows the user to easily set the data types supported by the knowledge base 120.

In some embodiments, the page may also include a second configuration area to receive a configuration of a target data source of the knowledge base 120. The knowledge base 120 may obtain data from the configured target data source, i.e., the user 105 may select the way of uploading the data or the source of the data on his/her own.

In some embodiments, the second configuration area presents at least one type of supported data source, the at least one type of data source including at least one of the following: a local data source, an online data source, a database, or custom data. For example, a page 400A of FIG. 4A provides a second configuration area 420 associated with the document type selection block in the first configuration area 410, which includes a plurality of document selection blocks, each of which corresponds to a target data source. The target data source here can include local documents (e.g., local documents in formats such as PDF, TXT, DOCX, etc., are supported), online data (e.g., obtaining content from an online web page), XX application (e.g., document data from any application or database can be obtained), customization (for example, creation and editing of document content can be customized).

In some embodiments, the page further includes a third configuration area to receive a name for the knowledge base 120. The user may name the knowledge base being created based on the third configuration area. For example, the page 400A of FIG. 4A provides a third configuration area 430 that includes a name input box to receive a name input by the user via natural language.

In some embodiments, the page further includes a fourth configuration area to receive description information for the knowledge base. The user may provide description information of the knowledge base based on the fourth configuration area, and the description information may indicate information such as the type, function, and other information of the knowledge base. For example, the page 400A of FIG. 4A provides a fourth configuration area 432 that includes a description input box to receive description information of the knowledge base input by the user via a natural language. The name and description information of the knowledge base 120 may be collectively referred to as metadata of the knowledge base. In some embodiments, if the knowledge base is associated with a specific application or workflow, then the corresponding application or workflow may determine whether to invoke the knowledge base based on the description information or metadata of the knowledge base when processing the corresponding query information. In some embodiment, if the application or workflow is built based on a machine learning model (such as a generative model), and if the knowledge base is associated with the application or workflow, then a prompt may be constructed based on description information or metadata of the knowledge base, to provide the model on which the above application or workflow depends. Then the model may determine whether to invoke the knowledge base to determine a response to the query information.

In some embodiments, the application management platform 110 may, in response to receiving the configurations of the target type and the target data source, import data of the target type from the target data source into the knowledge base.

In some embodiments, the application management platform 110 may, in response to receiving the configurations of the document type and local documents, present a page 400B as shown in FIG. 4B.

The page 400B of FIG. 4B provides a document upload area 435, which may indicate information such as the format, size, or number of pages of a document that can be received. In some embodiments, the document upload area 435 includes a document upload control 436. The application management platform 110 may, in response to a trigger on the document upload control 436, receive a document uploaded to the knowledge base 120 by the user 105 via the document upload control 436.

In some embodiments, the application management platform 110 may also receive a document that the user 105 drags into the document upload area 435. For example, the user 105 may select a document in a local file and drag the document to the document upload area 435 to implement uploading the document to the knowledge base 120.

In some embodiments, the page 400B of FIG. 4B also provides a document area 440, which may present at least one document that has been uploaded to the knowledge base 120. The document area 440 may further present upload information for the at least one document, and the upload information for the document may include a document name, a document upload status, and a document size.

In some embodiments, the document area 440 of FIG. 4B further provides a document operation control 441. Further, the application management platform 110 may, in response to a trigger on the document operation control 441, delete a document associated with the document operation control 441.

In some embodiments, the application management platform 110 may, in response to receiving a configuration of the document type and online data, present a page 400C as shown in FIG. 4C.

In some embodiments, the page 400C of FIG. 4C provides a new URL (Uniform Resource Locator, also referred to as a web page link) area 445. In some embodiments, the new URL area 445 includes a new URL control, and the application management platform 110 may, in response to a trigger on the new URL control, receive a URL link from a user, further obtain the document in the URL link and upload it to the knowledge base 120. As an example, the manner of obtaining the document in the URL link may be an online extraction.

In some embodiments, the application management platform 110 may, in response to receiving a configuration of the document type and customization, present a page 400D as shown in FIG. 4D.

In some embodiments, the application management platform 110 may, in response to the target data source being a type of the custom data, present a data input area. In the data input area, the user can customize or input the desired input to be imported. However, the application management platform 110 may import the input data received in the data input area into the knowledge base.

In some embodiments, the page 400D of FIG. 4D provides a document customization area 450 (corresponding to a “data input area” for the document type). The application management platform 110 can receive document content edited by a user in the document customization area 450, generate a document based on the document content, and upload the document to the knowledge base 120. As an instance, as shown in FIG. 4D, the document customization area 450 may include a custom name control 451 and a custom edit control 452. The custom name control 451 may be configured to receive a name of the document input by the user via natural language. The custom edit control 452 can be configured to receive a document content input by the user via the natural language. In some embodiments, there may also be a limitation on the amount of text in the natural language that can be received by the custom name control 451 and/or the custom edit control 452, and any limitation on the amount of text that can be input will be included within the scope of the present disclosure.

While customization of data of the document type is illustrated in FIG. 4D, it will be appreciated that for data of the table type, a corresponding data input area may also be provided for receiving user-defined table data, such as one or more table entries. In addition, for data of an image type, a corresponding data input area, such as a drawing board, may also be provided for receiving user-defined images.

In some embodiments, the application management platform 110 may, in response to completing the importing the data, present an index settings page corresponding to the target type, to receive index settings information for the imported data. It is noted that to invoke data in the knowledge base, corresponding data may be matched in the knowledge base based on index information associated with the index settings information.

In some embodiments, the application management platform 110 may, in response to completing the importing the document type data, present an index settings page corresponding to the document data type, to receive a segment index settings for the document, the segment index settings indicating at least one of the following: a segment rule, a segment length, or a segment pre-processing rule for a document. In this specification, a segment of a document corresponds to a data item for indexing.

In some embodiments, the application management platform 110 may, in response to completing the importing data for a table type, present an index settings page corresponding to the table type to receive table header index settings for a table, the table header index settings indicating a table header field to index a data item in the table.

In some embodiments, the application management platform 110 provides a document index settings area 455 in a page 400E of FIG. 4E. The application management platform 110 may receive document index settings information (also referred to as segment index settings) in the document index settings area 455. In an example, as shown in FIG. 4E, the document index settings area 455 provides an automatic segment and cleaning control 456 (also referred to as the input entrance for the default segment index settings) and a custom control 457 (also referred to as the input entrance for the user-defined segment index settings). It should be noted that the automatic segment and cleaning control 456 and the custom control 457 are either/or mutually exclusive controls.

In some embodiments, the application management platform 110 may, in response to a trigger on the automatic segment and cleaning control 456, determine the automatic segment and pre-processing rules as index settings information for the document. The automatic segment and pre-processing rules may be set by the skilled person as needed, and the present disclosure limited in this regard.

In some embodiments, the application management platform 110 may, in response to a trigger on the custom control 457, determine the custom segment rules, segment lengths, and pre-processing rules as index settings information for the document. As an example, a user may input the custom segment rules, segment lengths, and pre-processing rules in the custom control 457 via natural language.

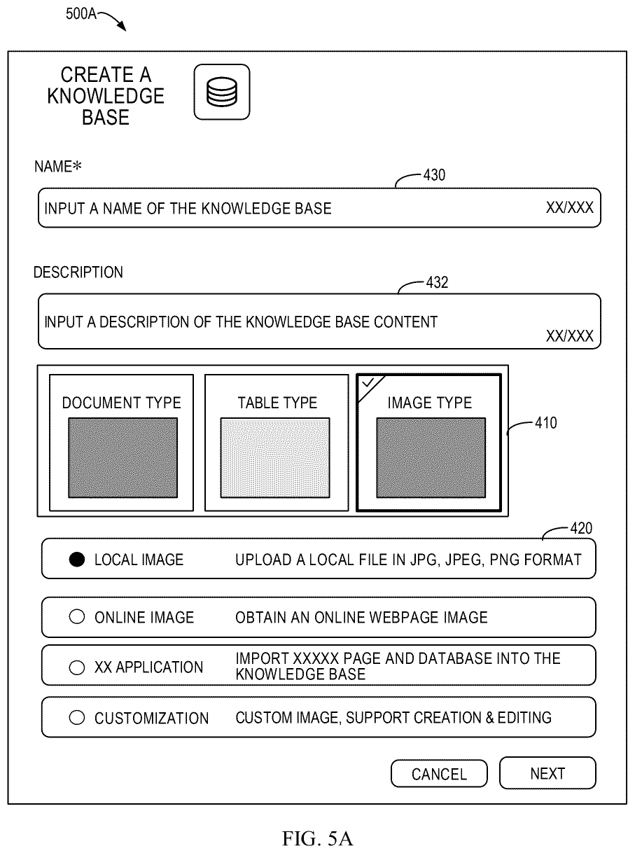

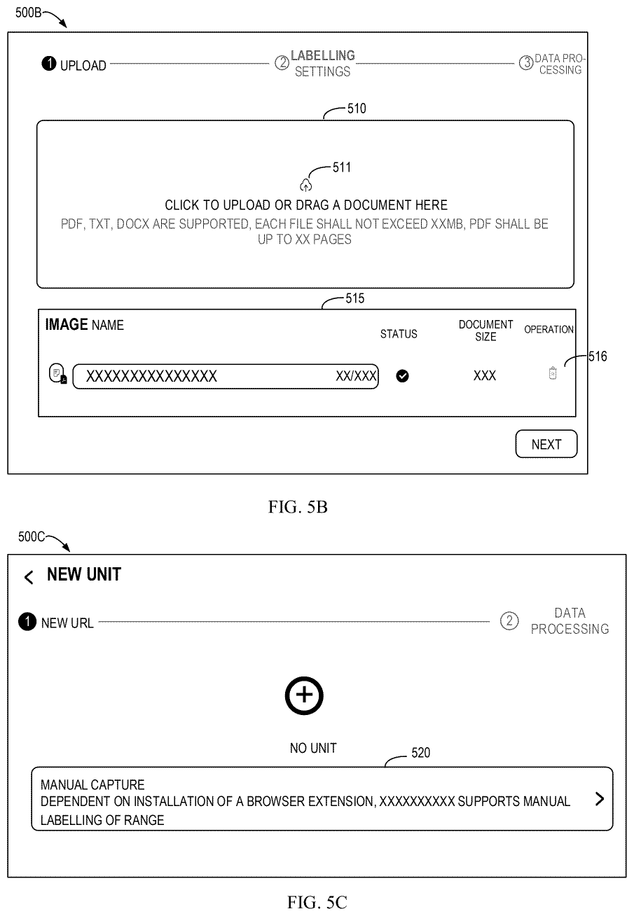

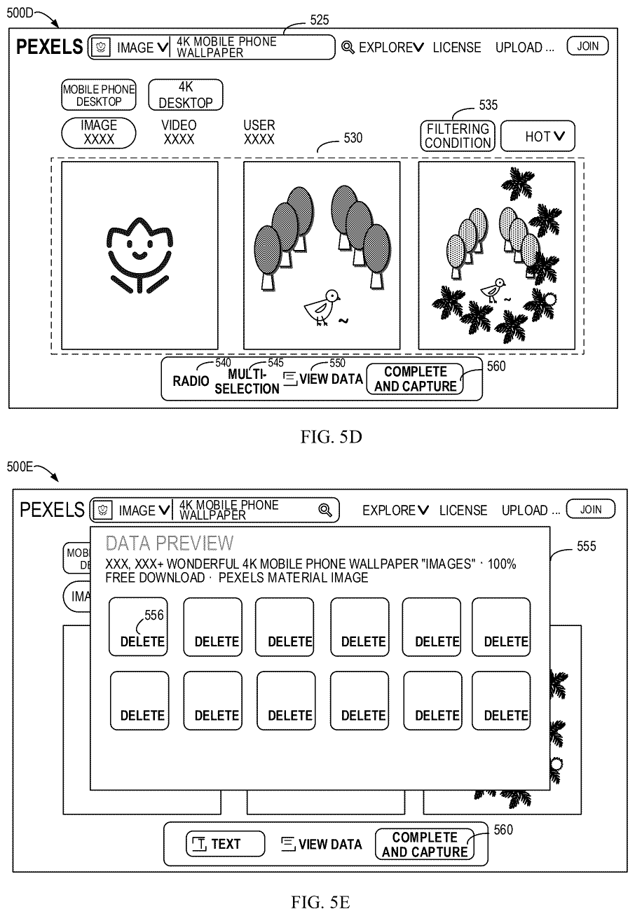

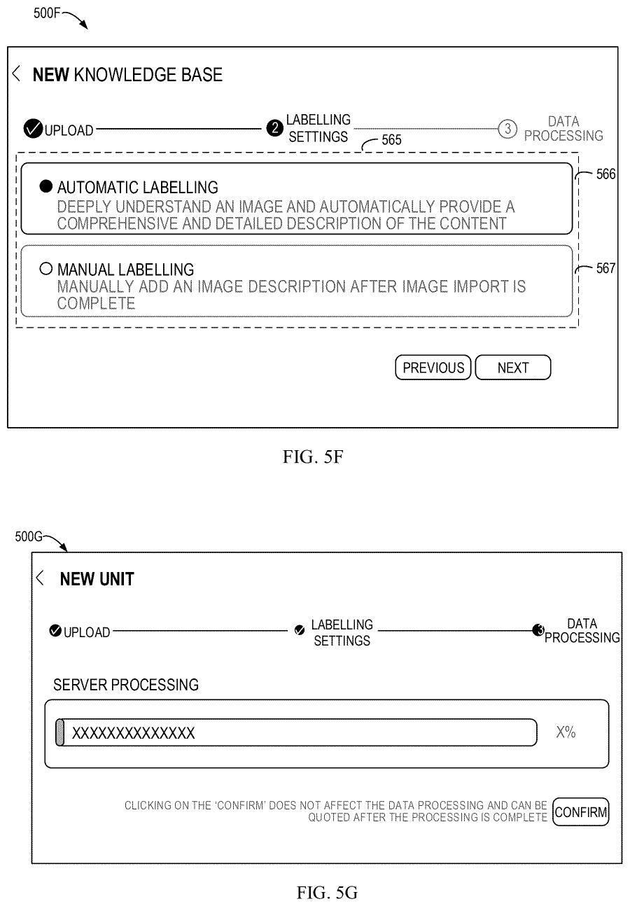

FIGS. 5A to 5G illustrate examples of pages 500A to 500G for creating a knowledge base of an image type according to some embodiments of the present disclosure. The pages 500A to 500G may be provided, for example, by the application management platform 110 shown in FIG. 1.

In some embodiments, still referring to FIG. 4A, the application management platform 110 may, in response to a selection operation on an image type selection box in the first configuration area 410, present a second configuration area 420 as shown on the page 500A of FIG. 5A.

In some embodiments, as shown in FIG. 5A, a second configuration area 420 associated with the image type selection block in the first configuration area 410 may include a plurality of image selection blocks, each of the image selection blocks may correspond to a target data source. The target data source can include a local image (e.g., a local image file supporting JPG, JPEG, PNG), an online image (e.g., obtaining an image from an online web page), an XX application (obtaining an image file from any application or database), and a customization (e.g., customizing the creation and editing of the image file).

In some embodiments, the application management platform 110 may, in response to receiving the configurations of the image type and the local image, present the page 500B as shown in FIG. 5B.

In some embodiments, the page 500B of FIG. 5B provides an image upload area 510, which may provide information indicating image formats, sizes, and the like that can be received. In some embodiments, the image upload area 510 includes an image upload control 511, and the application management platform 110 may, in response to a trigger on the image upload control 511, receive a document uploaded to the knowledge base 120 by the user 105 via the image upload control 511.

In some embodiments, the application management platform 110 may also receive images dragged by the user 105 into the image upload area 510. For example, the user 105 may select an image from a local image and drag it to the image upload area 510 to implement uploading the image to the knowledge base 120.

In some embodiments, the page 500B of FIG. 5B also provides an image area 515, which may present at least one image that has been uploaded to knowledge base 120. The image area 515 may further present upload information for the at least one image, and the upload information for the image may include an image name, an image upload status, and a size of the image.

In some embodiments, the image area 515 of FIG. 5B further provides an image manipulation control 516. Further, the application management platform 110 may, in response to a trigger on the image manipulation control 516, delete an image associated with the image manipulation control 516.

In some embodiments, the application management platform 110 may, in response to receiving a configuration of an image type and an online image, present a page 500C as shown in FIG. 5C.

In some embodiments, the manual capture area 520 is provided on the page 500C of FIG. 5C. In some embodiments, the application management platform 110 may, in response to receiving a trigger on the manual capture area 520, receive a URL link from a user, further obtain an image in the URL link, and upload it to the knowledge base 120. As an example, the manner of obtaining the image in the URL link may be to install a browser extension program in the manual capture area 520 and rely on the browser extension program to obtain the image in the URL link.

In some embodiments, still referring to FIG. 5C, the application management platform 110 may further, in response to receiving a URL link from a user in the manual capture area 520, present a page 500D as shown in FIG. 5D.

In some embodiments, the application management platform 110 may provide an image display area 530 on the page 500D of FIG. 5D. The image display area 530 may present at least one image associated with a URL link.

In some embodiments, the application management platform 110 may also provide an image search control 525 on the page 500D. Further, the application management platform 110 may receive input information from the user 105 in the image search control 525 and update the image display area 530 to present at least one image associated with the input information.

In some embodiments, the application management platform 110 may also provide an image filtering control 535 on the page 500D. Further, the application management platform 110 may receive a conditional selection operation of the user 105 for the image filtering control 535 and update the image display area 530 to present at least one image associated with the filtering control 535.

In some embodiments, the application management platform 110 may also provide a radio control 540 in the page 500D. Further, the application management platform 110 may, in response to a trigger on the radio control 540, receive one image selected by the user 105 in the image display area 530.

In some embodiments, the application management platform 110 may also provide a multi-selection control 545 in the page 500D. Further, the application management platform 110 may, in response to a trigger on the multi-selection control 545, receive a plurality of images selected by the user 105 in the image display area 530.

In some embodiments, the application management platform 110 may also provide a view data control 550 in the page 500D. Further, the application management platform 110 may, in response to a trigger on the view data control 550, present the page 500E as shown in FIG. 5E.

In some embodiments, the page 500E of FIG. 5E presents an image preselection area 555. The application management platform 110 may present a thumbnail of the at least one image selected by the user 105 based on the single-selection or multi-selection control in the image preselection area 555.

In some embodiments, the application management platform 110 may also provide an image deletion control 556 in a thumbnail of at least one image in the image preselection area 555. Further, the application management platform 110 may, in response to a trigger on the image deletion control 556, delete an image associated with the image deletion control 556 in the image preselection area 555.

In some embodiments, the application management platform 110 may also provide a complete and capture control 560 in the page 500D. Further, the application management platform 110 may, in response to a trigger on the complete and capture control 560, present the page 500F as shown in FIG. 5F.

In some embodiments, the application management platform 110 may, in response to the target type being an image type, present an index settings page corresponding to the image type to receive labeling settings for an image, the labeling settings indicating a text label to index an image.

In some embodiments, the application management platform 110 provides an image index settings area 565 in the page 500F of FIG. 5F. The application management platform 110 may receive image index settings information (also known as labeling settings) in the image index settings area 565. As an example, as shown in FIG. 5F, the image index setting area 565 provides an automatic labeling control 566 (also referred to as an automatic generation entrance for the labeling settings) and a manual labeling control 567 (also referred to as an input entrance for the user-customized labeling settings). It should be noted that the automatic labeling control 566 and the manual labeling control 567 are either/or mutually exclusive controls.

In some embodiments, the application management platform 110 may, in response to a trigger on the automatic labeling control 566, deeply understand the image to automatically generate a content description of the image and use the content description as image index settings information. In this specification, the automatic labeling of the image may be implemented as OCR (Optical Character Recognition) text recognition, which extracts the text information in the image as the labeling information. The automatic labeling of the images may also be implemented here as an image processing model, and the present disclosure does not impose any limitation on the specific image processing model.

In some embodiments, the application management platform 110 may, in response to a trigger on the manual labeling control 567, determine the custom image description as index settings information for the image. As an example, a user may input the image description via natural language using the manual labeling control 567.

In some embodiments, the application management platform 110 may, in response to receiving the index settings information, create a knowledge base 120 of the target type based on the index settings information. In some embodiments, the received index settings information can be used to construct an index of the data. The application management platform 110 can process the imported data of the target type based on the index settings information to create the knowledge base 120 of the target type, the created knowledge base 120 including a plurality of data items indexable after processing.

In some embodiments, the application management platform 110 may, in response to receiving index settings information for an image, present a page 500G as shown in FIG. 5G.

In some embodiments, the application management platform 110 may present an image processing process in the page 500G. The image processing process may include image processing progress.

In some embodiments, the application management platform 110 may, in response to a view request for a knowledge base list, present a knowledge base list page including a plurality of class view entrances corresponding to each of the plurality of data types.

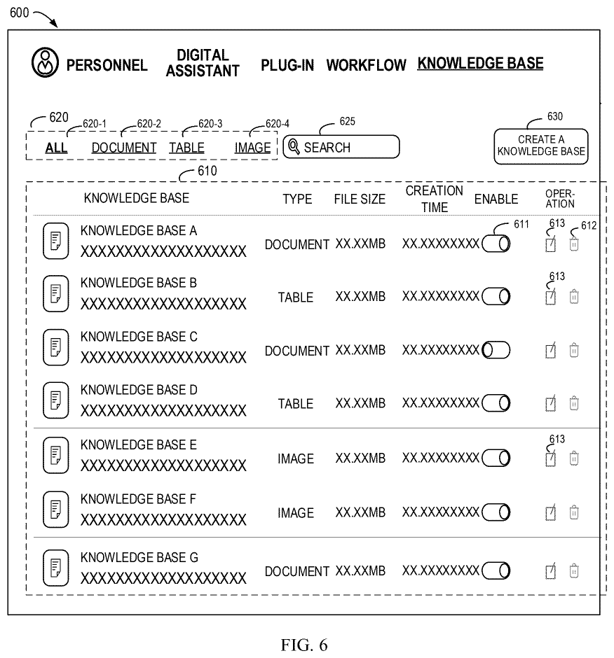

FIG. 6 illustrates an example of a page 600 for viewing a list of knowledge bases according to some embodiments of the present disclosure. The page 600 may be provided, for example, by the application management platform 110 shown in FIG. 1.

In some embodiments, as shown in FIG. 6, the application management platform 110 may, in response to a knowledge base list view request, present a page 600 of a knowledge base view list. As an example, the page 600 may present a knowledge base list area 610. The knowledge base list area 610 may present a plurality of knowledge bases 120 (e.g., Knowledge Base A, Knowledge Base B, . . . ), the plurality of knowledge bases 120 may include a plurality of data types (e.g., Knowledge Base A is of a document type, Knowledge Base B is of a table type, and Knowledge Base E is of an image type). The knowledge base list area 610 may also present knowledge base information corresponding to each knowledge base 120, and the knowledge base information may include a knowledge base type, a knowledge base size, a knowledge base creation time, etc.

In some embodiments, the application management platform 110 may provide an enablement control 611 in the knowledge base list area 610. Further, the application management platform 110 may, in response to a trigger on the enablement control 611, switch an enablement state of the knowledge base 120 or an enablement state of the data in the knowledge base associated with the enablement control 611 to be ON or OFF. As an example, an enablement state of the knowledge base 120 being ON indicates that data in the knowledge base 120 can be invoked, and an enablement state of the knowledge base 120 being OFF indicates that invocation of data in the knowledge base 120 is not allowed.

In some embodiments, the application management platform 110 may provide a knowledge base deletion control 612 in the knowledge base list area 610. Further, the application management platform 110 may, in response to a trigger on the knowledge base deletion control 612, delete the knowledge base 120 associated with the knowledge base deletion control 612 in the knowledge base list area 610.

In some embodiments, the application management platform 110 may provide a plurality of class view entrances 620 in the page 600. Each class view entrance is associated with a knowledge base 120 of a corresponding data type. As an example, as shown in FIG. 6, the application management platform 110 provides an all-class view entrance 620-1, a document class view entrance 620-2, a table class view entrance 620-3, and an image class view entrance 620-4 (collectively or individually referred to as class view entrances 620) in the page 600. The first data type corresponding to the all-class view entrance 620-1 is a database 120 of all data types, the first data type corresponding to the document class view entrance 620-2 is a document type, the first data type corresponding to the table class view entrance 620-3 is a table type, and the first data type corresponding to the image class view entrance 620-4 is an image type.

In some embodiments, the application management platform 110 may, in response to a selection of a class view entrance corresponding to a first data type among the plurality of data types, present a created knowledge base 120 of the first data type in the knowledge base list area 610.

In some embodiments, the application management platform 110 may also provide a knowledge base search input box 625 in the page 600. Further, the application management platform 110 may receive search information input by the user 105 in the knowledge base search input box 625, updating the knowledge base list area 610 to present the knowledge base 120 associated with the search information.

In some embodiments, the application management platform 110 may also provide a knowledge base creation control 630 in the page 600. Further, the application management platform 110 may, in response to a trigger on the knowledge base creation control 630, invoke the application management platform 110 to present the page 400A for knowledge base creation as shown in FIG. 4A.

In some embodiments, the application management platform 110 may, in response to a detail view request for the knowledge base 120, present a detail page of the knowledge base 120. The detail page includes an aggregated display of a plurality of processed data items and may also include: metadata of the knowledge base 120 (the name and description information of the knowledge base 120 may be collectively referred to as the metadata of the knowledge base), a list of files imported into the knowledge base 120, index settings information corresponding to the knowledge base, and/or the number of data items.

In some embodiments, the application management platform 110 may also provide a detail view control 613 in the knowledge base list area 610. Further, the application management platform 110 may, in response to a trigger on the detail view control 613, present a detail page of the knowledge base 120 associated with the detail view control.

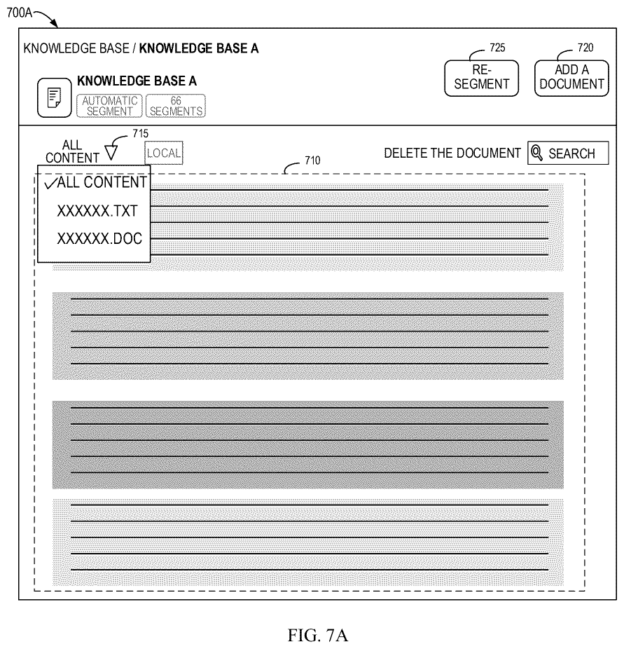

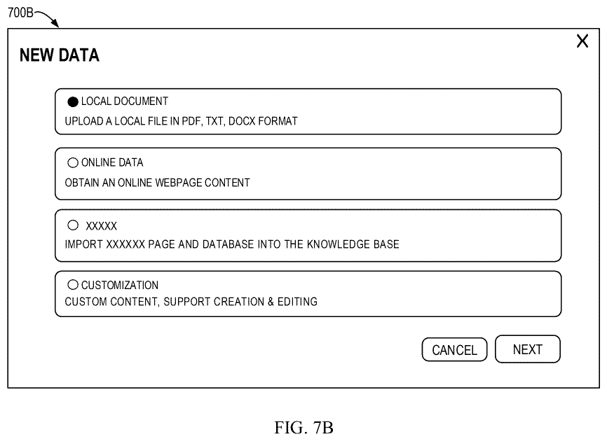

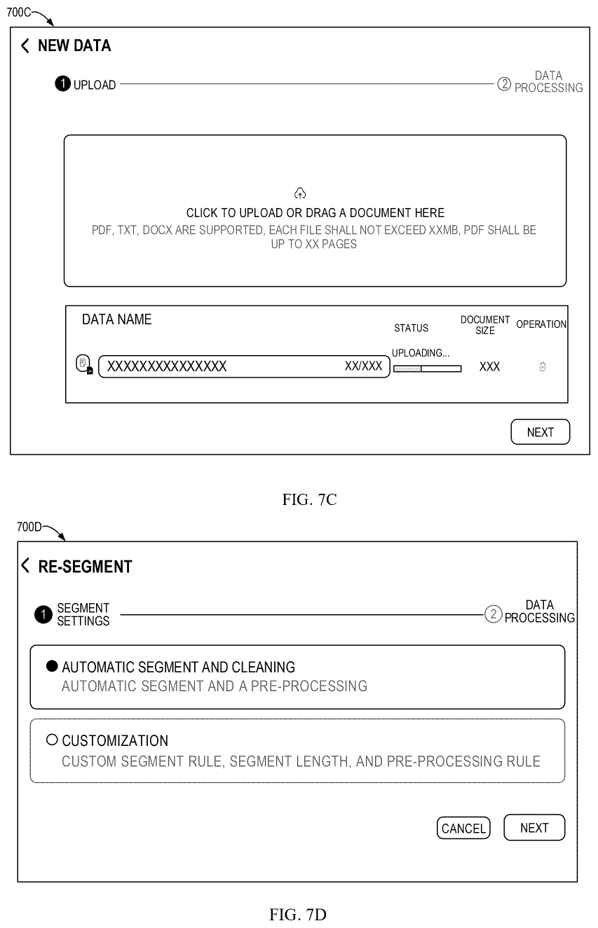

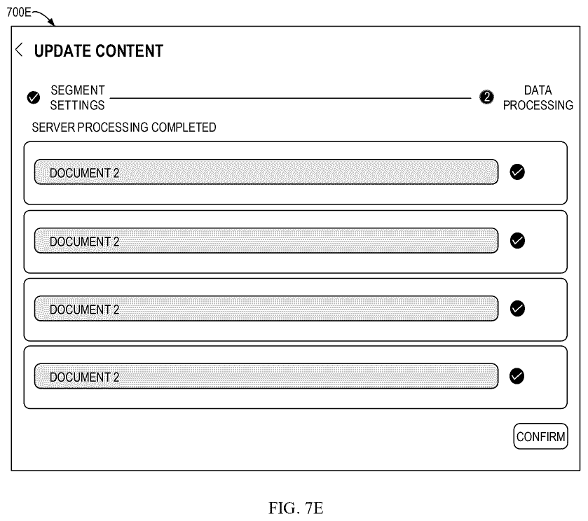

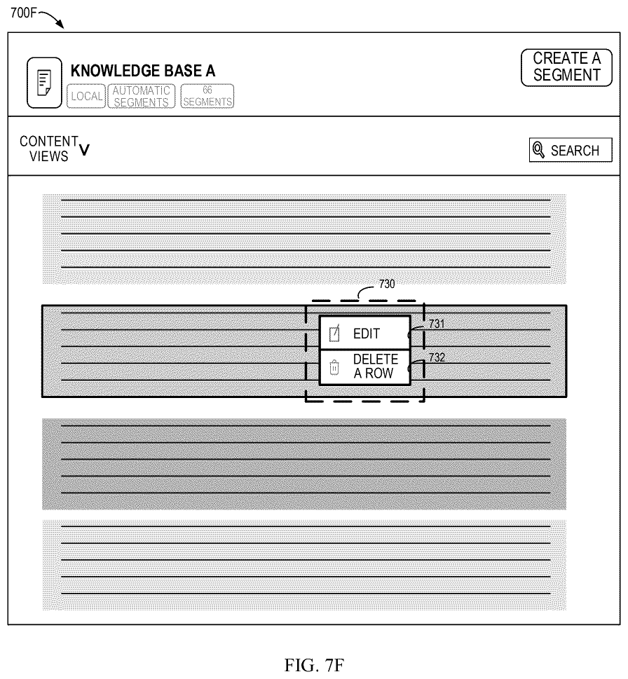

In some embodiments, the application management platform 110 may, in response to a trigger on the detail view control 613 associated with the knowledge base 120 of the document type, present a detail page 700A of the knowledge base 120 of the document type as shown in FIG. 7A.

FIGS. 7A to 7F illustrate examples of pages 700A to 700F for managing a knowledge base of a document type according to some embodiments of the present disclosure. The pages 700A to 700F may be provided, for example, by the application management platform 110 shown in FIG. 1.

In some embodiments, the application management platform 110 may present the detail page 700A of Knowledge Base A of the document type, as shown in FIG. 7A. The application management platform 110 may present a document display area 710 on the detail page 700A, and the document display area 710 may present a plurality of indexable data items. As an example, in the detail page 700A shown in FIG. 7A, data corresponding to each color block is an indexable data item (in this case, a document type).

In some embodiments, the application management platform 110 may, in response to a selection of a target file in a list of files, present an aggregated display of data items obtained from the processing of the target file in a details page.

In some embodiments, the application management platform 110 may provide a document list control 715 on the detail page 700A. Further, the application management platform 110 may, in response to a trigger on the document list control 715, present a list of documents (documents may be referred to as files) imported into the knowledge base 120. A plurality of document selection items may be presented in the list of documents, and the document selection items may include a full content selection item and at least one document name selection item associated with an individual document. As an example, as in detail page 700A of FIG. 7A, the list of documents includes a full content selection item, an XXXXXX.TXT selection item, and an XXXXXX.DOC selection item, etc.

In some embodiments, the application management platform 110 may, in response to a trigger on a document selection item, update the document display area 710 to present at least one indexable data item associated with the document selection item. As an example, as in the detail page 700A of FIG. 7A, the application management platform 110 may, in response to the trigger on the all-content selection item, update the document display area 710 to present all data items in the knowledge base 120. The application management platform 110 may also, in response to a trigger on the XXXXXX.TXT selection item, update the content presenting XXXXXX.TXT in the document display area 710.

In some embodiments, the application management platform 110 may also present metadata corresponding to the knowledge base 120 (i.e., a name and descriptive information of the knowledge base 120) in the detail page 700A, the description information may indicate a type, function, etc. of the knowledge base 120.

In some embodiments, the application management platform 110 may also present index settings information corresponding to the knowledge base 120 (i.e., a segmentation strategy for the knowledge base 120) in the detail page 700A.

In some embodiments, the application management platform 110 may also present the number of data items (i.e., a total number of segments of data items) in the detail page 700A.

In some embodiments, the application management platform 110 may also present a new data addition portal in the detail page 700A. As an example, the detail page 700A as in FIG. 7A provides an addition document control 720, and the application management platform 110 may, in response to a trigger on the addition document control 720, present a new data page 700B as shown in 7B. The method of selecting uploaded data for the new data page 700B herein may be referred to as covered by the second configuration area 420 in the 400A page of FIG. 4A and will not be repeated here.

In some embodiments, the application management platform 110 may, in response to selecting a method of uploading a local document in the new data page 700B, present an upload data page 700C as shown in FIG. 7C. The method of uploading the upload data page 700C may be referred to in the method covered by the document upload area 435 of the 400B page of FIG. 4B and will not be described herein.

In some embodiments, the application management platform 110 may also present a trigger entrance for reindexing in the detail page 700A. As an example, the detail page 700A as in FIG. 7A provides a re-segment control 725, and the application management platform 110 may, in response to a trigger on the re-segment control 725, present a re-segment page 700D as shown in 7D. The method of segmentation of the re-segment page 700D may be referenced to the method involved in the document index settings area 455 in the page 400E of FIG. 4E and will not be repeated herein.

In some embodiments, the application management platform 110 may, in response to the completion of the segment settings of the re-segment page 700D, present an update content page 700E as shown in FIG. 7E. As can be seen in the update content page 700E, based on the segment settings of the re-segment page 700D, the updating of segment settings may be implemented for all of the data items in the knowledge base 120 (i.e., the index settings information is updated).

In some embodiments, the application management platform 110 may also present the settings entrance for the update frequency in the detail page 700A. As an example, the settings page for the update frequency only appears to be presented in the detail page of the knowledge base 120 that selects the target data source as the online data. The application management platform 110 may provide an update frequency control in the detail page of the knowledge base 120 for which the target data source is selected as the online data. Further, the application management platform 110 may, in response to a trigger on the update frequency control, present an update frequency selection item. The update frequency selection item may include no automatic updates, daily updates, every 3 days, every 7 days, and the like. The update frequency is the frequency of updating the document from the online data, e.g., daily update is updating the document from the online data once a day. The specific update frequency selection item can be set as desired, and the present disclosure is not limited in this regard.

In some embodiments, the application management platform 110 may, in response to a first predetermined operation (long press or double click, etc.) on a target data item of the plurality of data items, further present, in the details page 700A, a processing control associated with the target data item. As an example, as shown in FIG. 7F on page 700F, the application management platform 110 may, in response to the first predetermined operation on the target data item, present a processing block 730 associated with the target data item. The processing block 730 may include an edit option 731 and a delete option 732. Further, the application management platform 110 may, in response to the triggering on the edit document control 731, receive, in an editing mode, editing information from the user 105 on the data item associated with the edit document control 731, enabling modification of the data item. The application management platform 110 may also, in response to a trigger of the delete row control 732, delete the data item associated with the delete row control 732.

In some implementations, the application management platform 110 may receive a modification request for the knowledge base 120, the modification request indicating at least one of the following: a modification of metadata of the knowledge base, a modification of index settings information of the knowledge base, or an addition of data to the knowledge base.

In some embodiments, the application management platform 110 may, in response to a second predetermined action (long press or double click, etc.) on the knowledge base name on the detail page 700A, receive user input of modification information for the metadata of the knowledge base (including the name of the knowledge base and the description information) via natural language, and thereby modify the metadata of the knowledge base 120.

In some embodiments, for a knowledge base of the table type, the layout of the detail page and the information presented may be similar to a knowledge base of the document type shown with respect to FIGS. 7A through 7F. The difference is that in the case of the table type knowledge base, individual entries of the table (corresponding to indexable data items in the table) may be presented to the user one by one.

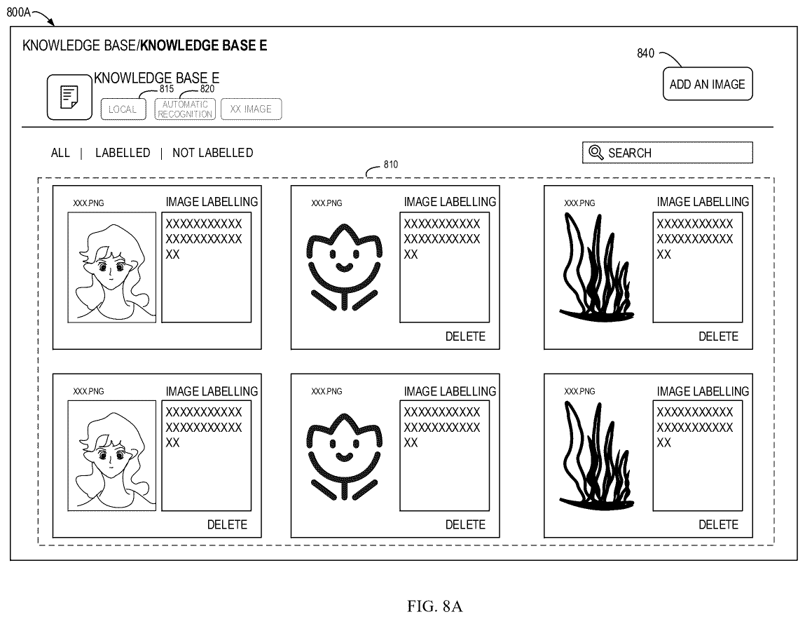

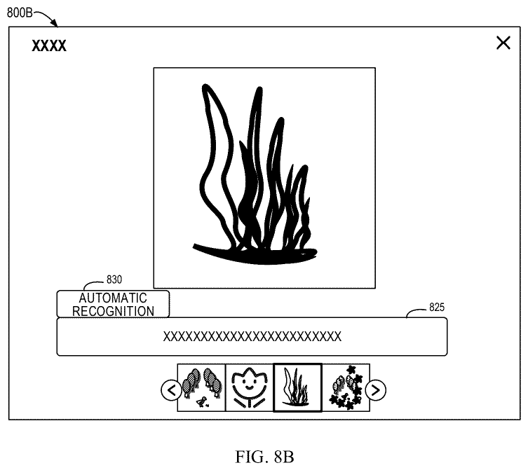

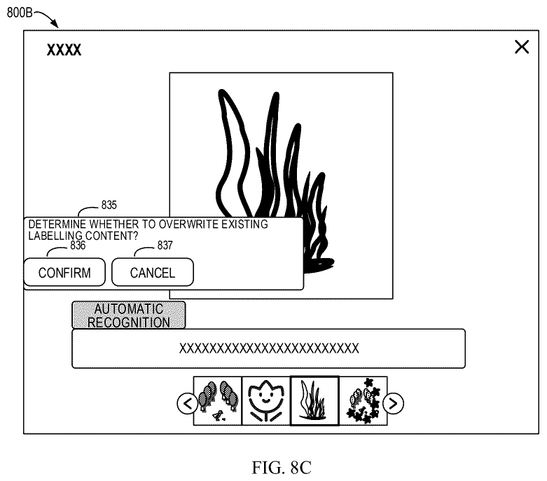

In some embodiments, still referring to FIG. 6, in response to a trigger on the detail view control 613 associated with the knowledge base 120 of the image type, the application management platform 110 may present a detail page 800A of the knowledge base 120 of the image type as shown in FIG. 8A.

FIGS. 8A to 8C illustrate examples of pages 800A to 800C for managing a knowledge base of image types according to some embodiments of the present disclosure. The pages 800A to 800C may be provided, for example, by the application management platform 110 shown in FIG. 1.

In some embodiments, the application management platform 110 may present a detail page 800A of the knowledge base 120 of the image type as shown in FIG. 8A associated with the Knowledge Base E. The application management platform 110 may present an image display area 810 on the detail page 800A, and the image display area 810 may present a plurality of indexable data items. As an example, in the detail page 800A shown in FIG. 8A, each block containing an image and an image label is an indexable data item (in this specification, an image type).

In some embodiments, the application management platform 110 may, in the detail page 800A, present a list of images in the imported Knowledge Base E (including image content (including image and image name) for each data item) and a corresponding text label for the images. The application management platform 110 may present a method of uploading the data items in the knowledge base in the detail page 800A. The method of uploading may include a local image, an online image, an XX application, and a customization. As an example, the interface 800A in FIG. 8A presents an upload method area 815, and the upload method area 815 presents local to indicate that the method of uploading the data item in the Knowledge Base E is a local image. Correspondingly, online may be presented in the upload method area 815 when the method of uploading the data item in the Knowledge Base E is an online image, XX application may be presented in the upload method area 815 when the method of uploading the data item in the Knowledge Base E is XX application, and customization may be presented in the upload method area 815 when the method of uploading the data item in the Knowledge Base E is customized.

In some embodiments, the application management platform 110 may also present a method of labeling the data items in that knowledge base in the detail page 800A. As an example, the interface 800A in FIG. 8A presents a labeling method area 820, and the labeling method area 820 presents an automatic recognition indicating that the method of labeling the data item in the Knowledge Base E is automatic (or referred to as intelligent labeling). Correspondingly, the data items in the Knowledge Base E may be manually recognized in the upload method area 815 when the method of labeling the data items in the Knowledge Base E is manual.

In some embodiments, the application management platform 110 may, in response to a detail view request for a target image in the plurality of images in the knowledge base 120, also present the target image on the detail page 800A. As an example, as in the detail page 800A of FIG. 8A, the application management platform 110 may, in response to a detail view request for a target image (receiving an action of clicking on the image or labeling the image), present a target image page 800B as shown in FIG. 8B.

In some embodiments, the application management platform 110 may present image content (image name and image) and image labeling (textual labeling of the image) of the target image in the target image page 800B of FIG. 8B. The application management platform 110 may also provide a labeling input box 825 (also known as a labeling display area) in the target image page 800B. Further, the application management platform 110 may receive user input of labeling information via natural language to update the image labeling of the target image.

In some embodiments, the application management platform 110 may also provide an automatic recognition control 830 in the target image page 800B. Further, when the image labeling content of the target image is non-empty, the application management platform 110 may, in response to the trigger on the automatic recognition control 830, present an overlay reminder area 835 as shown in FIG. 8C. As an example, as shown in FIG. 8C, the overlay reminder area may present a reminder message, and the reminder message may be a textual content “Determine to overlay existing labeled content”.

In some embodiments, further, the overlay reminder area 835 may be provided with a Confirm option 836 and a Cancel option 837, and the application management platform 110 may automatically generate the labeling content for the target image in response to a trigger on the Confirm option 836, and the application management platform 110 may also cancel the automatic generation of the labeling content for the target image in response to a trigger on the Cancel option 837.

In some embodiments, when the image labeling content of the target image is empty, the application management platform 110 may, in response to a trigger on the automatic recognition control 830, automatically generate the labeling content for the target image.

In some embodiments, the method of automatically generating labeling content for the target image may be to generate the labeling content by relying on a relevant image model for deep understanding of the image or performing OCR for text recognition to extract textual information in the image as the labeling information.

In some embodiments, the application management platform 110 may also provide an addition image control 840 in the target image page 800A. Further, the application management platform 110 may, in response to a trigger on the addition image control 840, add a new image to the knowledge base. The specific method of adding an image referring to the image uploading methods covered in FIGS. 5A through 5G above will not be described herein.

As mentioned above, the created knowledge base may be linked to an application or workflow. In some embodiments, the application management platform 110 may present, in a creation page of a target application or a target workflow, a knowledge base selection area indicating the plurality of data types. In response to a selection of the target type among the plurality of data types, the application management platform 110 may present, in the knowledge base selection area, at least the knowledge base corresponding to the target type. In response to a selection of the presented knowledge base being received, the application management platform 110 may associate the selected knowledge base with the target application or the target workflow.

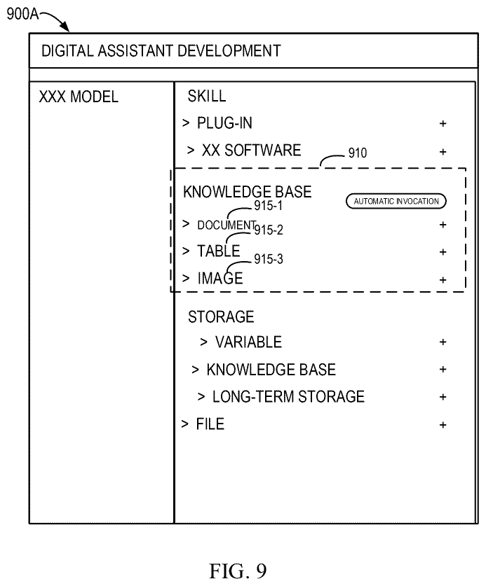

FIG. 9 illustrates an example of a creation page 900 for configuring a knowledge base in a third-party application according to some embodiments of the present disclosure. The third party application may be a target application or a target workflow. In the example of FIG. 9, it is assumed that the application to be configured with the knowledge base is a digital assistant. For example, when developing a digital assistant type of application, it is expected that the digital assistant will be associated with a specific knowledge base to perform information retrieval from the knowledge base so that question and answer interactions with the user can be better implemented. The creation page 900 may be provided, for example, by the application management platform 110 shown in FIG. 1.

In some embodiments, the application management platform 110 may present a creation page 900 for the digital assistant as shown in FIG. 9. The application management platform 110 may provide a knowledge base selection area 910 in the creation page 900. The knowledge base selection area 910 may provide options corresponding to a plurality of data types for the knowledge base, a document option, a table option, an image option. As an example, as in the creation page 900 of FIG. 9, the knowledge base selection area 910 may include a document option 915-1, a table option 915-2, and an image option 915-3 (individually or collectively referred to as data type option 915). The creator of the digital assistant may determine to associate the digital assistant with one or more knowledge bases as desired and select the corresponding type for the knowledge base association.

For example, the application management platform 110 may, in response to a selection of a target type in the plurality of data types, present in the knowledge base selection area 910 at least one or more knowledge bases 120 that have been created and may be associated with the target type. As an example, as in the creation page 900 of FIG. 9, the application management platform 110 may present the knowledge base 120 of the document type in response to a selection of the document option 915-1 of the plurality of data type options 915.

In some embodiments, the application management platform 110 may, in response to receiving a selection of the knowledge base 120 on the creation page 900, associate the knowledge base 120 with the target application or target workflow. After the association is complete, the target application or target workflow determines whether to invoke the associated knowledge base as needed (for example, based on the received query information). In the case of determining the need of invocation, the processing of the query information for the target application or target workflow may be performed by invoking the data in the associated knowledge base 120.

In some embodiments, the application management platform 110 may also provide a memory selection area and/or a skill configuration area on the creation page 900 to configure memory or corresponding skills for a target application or target workflow.

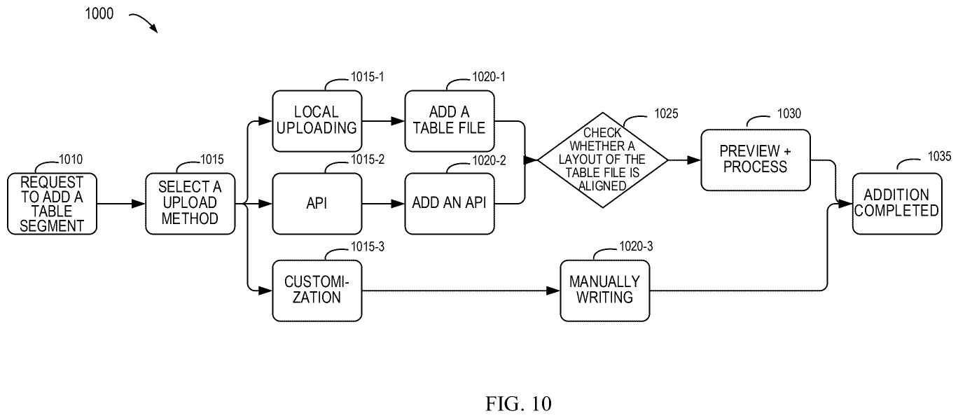

FIG. 10 illustrates a flowchart of an example process 1000 for adding table type data according to some embodiments of the present disclosure. The process 1000 of adding table type data may be performed in the application management platform 110 as described before (taking the performing in the application management platform 110 as an example, the method of performing in the application management platform 110 is the same and will not be repeated here). The process 1000 is described below with reference to FIG. 1.

As shown, at block 1010, the application management platform 110 may receive a request to add a table segment 1010.

At block 1015, the application management platform 110 may receive the selected method of uploading which may include a local upload 1015-1, an API interface upload 1015-2, and a customized upload 1015-3.

After selecting the local uploading 1015-1, block 1020-1 may be executed. At block 1020-1, the application management platform 110 receives the table file as a local file, e.g., a table file of the user's terminal device.

After selecting the API 1015-2, block 1020-2 may be executed. At the block 1020-2, the application management platform 110 may receive the table file associated with the API interface. The API interface in this specification can be any application that can provide table type files.

After selecting the customization 1015-3, block 1020-3 may be executed. At the block 1020-3, the application management platform 110 may receive manually written table files.

After executing the block 1020-1 or 1020-2, block 1025 is executed. At the block 1025, the application management platform 110 may verify that the layout of the table is aligned, as well as perform an alignment operation on the forms whose layout is not aligned.

After executing block 1025, block 1030 is executed. At block 1030, the application management platform 110 previews the table file and sets index settings information (e.g., header structure settings indicating the header fields in the table for indexing data items) for the table file.

After executing block 1030 or block 1020-3, block 1035 is executed. At block 1035, the application management platform 110 may complete the addition of the table in response to the completion of the upload of the table file.

In some embodiments, one or more types of index bases may be constructed for the data imported in the knowledge base of the target type. The processed plurality of data items are stored in the plurality of types of index bases and indexed by the plurality of types of data indexes, respectively. Pre-constructing multiple types of data indexes helps to provide a diverse method of data retrieval in subsequent invocations of the knowledge base. In some embodiments, for the document-type knowledge base 120, at least two types of index bases may be established for the data items imported therein. A first index base may be a keyword-dependent full-text search engine (e.g., ES (Elasticsearch)). The second index base may be a vector-based text relevance query engine (e.g., Viking) in which feature vectors corresponding to individual segments of the document (i.e., data items) are used as the basis for relevance retrieval. The creation of the index base may e.g. be in the data processing phase of the knowledge base creation.

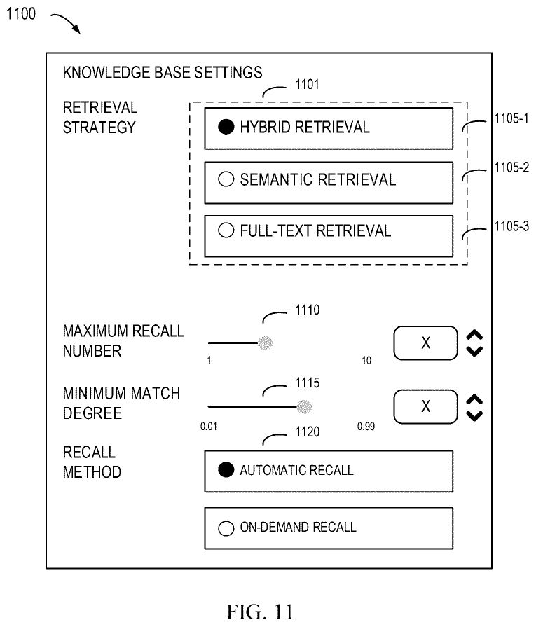

FIG. 11 illustrates an example of a page 1100 for settings of a knowledge base application according to some embodiments of the present disclosure. The page 1100 may be provided, for example, by the application management platform 110 shown in FIG. 1.

The application management platform 110 may receive an application settings request for the knowledge base 120, presenting the knowledge base application settings page 1100 of FIG. 11. The application management platform 110 may provide a search strategy area 1101 at the page 1100, and the search strategy area 1101 may include a hybrid search option 1105-1, a semantic search option 1105-2, a full-text search option 1105-3 (individually or collectively referred to as search option 1105). The application management platform 110 may, in response to the selection of the search option 1105, set the search strategy of the knowledge base 120 to the search strategy associated with the search option 1105.

If the semantic search option 1105-2 is enabled, then for the data in the knowledge base 120, a semantic retrieval of the document data may be performed based on the feature vectors in the second index base. If full-text search option 1105-3 is enabled, then for the data in knowledge base 120, a full-text search of the document data may be performed by keywords based on the first index base. If the hybrid search option 1105-1 is enabled, then both semantic and full-text searches of the document data may be performed based on the first index base and the second index base. As an example, as in page 1100 of FIG. 11, the application management platform 110 may set the search strategy of the knowledge base 120 to a hybrid search strategy in response to the selection of the hybrid search option 1105-1.

In some embodiments, the application management platform 110 may provide a maximum recall number settings area 1110, a minimum match degree settings area 1115, and/or a recall method settings area 1120 at the page 1100. Further, the application management platform 110 may receive a set maximum recall number (e.g., the range may be 1-10) at the maximum recall number settings area 1110. The application management platform 110 may receive a set minimum match (e.g., the range may be 0.01-0.99) in the minimum match setting area 1115. The application management platform 110 may receive the set recall method (i.e., the manner in which the data is recalled, e.g., automatic recall or on-demand recall) in the recall method setting area 1120.

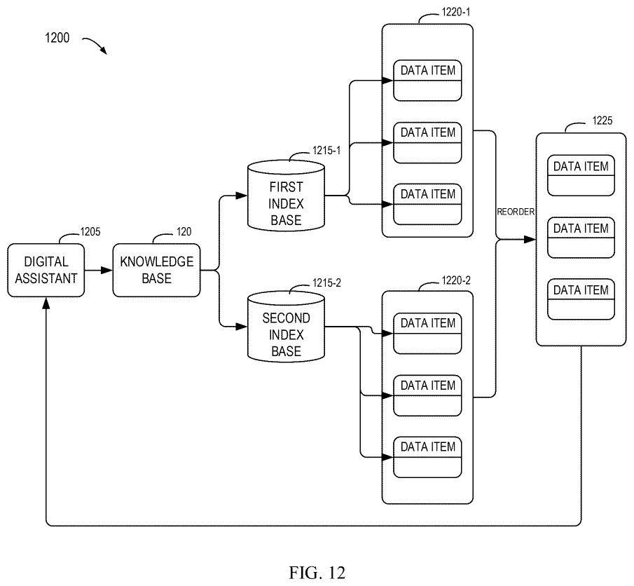

FIG. 12 illustrates a flowchart of an example process 1200 of retrieving data of a knowledge base based on hybrid retrieval according to some embodiments of the present disclosure. The process 1200 of retrieving data of the knowledge base based on the hybrid retrieval may be performed in the application management platform 120 as described before. The process 1200 is described below with reference to FIG. 1.

In the example of FIG. 12, it is assumed that the knowledge base 120 of the document type is associated with the digital assistant 1205. the application management platform 120 may, in response to receiving a query for the knowledge base 120, search, based on a search algorithm corresponding to each of the plurality of types of index libraries, for a plurality of sets of data items that match the query from the plurality of types of index libraries, respectively; and select, based on a sorting result of the plurality of sets of data items, at least one data item from the plurality of sets of data items as a response to the query.

As shown in FIG. 12, the application management platform 120 may, in response to a request by the digital assistant 1205 to obtain data for the knowledge base 120, index at least one data item 1220-1 (e.g., top-K1 data items) matching the query from the knowledge base 120 based on a first index base 1215-1 and at least one data item 1220-2 matching the query from the knowledge base 120 based on a second index base 1215-2, respectively (e.g., top-K2 data items), where K1 and K2 are positive integers greater than or equal to 1, respectively. The first index base 1215-1 may be a full-text search engine (e.g., ES (Elasticsearch)) based on dependency keywords. The second index base 1215-2 may be a vector-based text relevance query engine (e.g., Viking) in which feature vectors corresponding to individual segments (i.e., data items) of a document are used as the basis for relevance retrieval. Thereafter, a reordering may be performed on the at least one data item 1220-1 and the at least one data item 1220-2. At least one filtered data item 1225 may be obtained based on the result of the reordering. For example, top-K data items may be selected out of the K1+K2 data items, with K being a positive integer greater than or equal to one. In some embodiments, a reordering may be performed based on the RFF algorithm (inverted rank fusion Reciprocal Rank Fusion algorithm, an algorithm that combines multiple ranked lists into a single aggregated list) for the set of two data items given by the two index bases. The at least one filtered data item 1225 is returned to the digital assistant 1205 as a retrieval result of the knowledge retrieval.

It should be appreciated that while two index bases are used in the related depictions of FIGS. 11 and 12, more different types of index bases relying on different retrieval solutions may in fact exist.

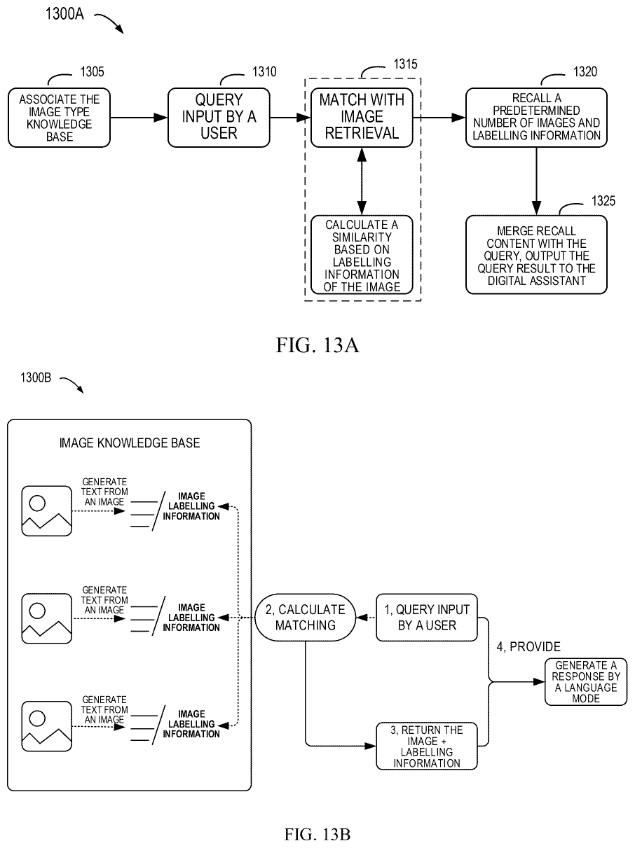

FIGS. 13A and 13B illustrate flowcharts of example processes 1300A and 1300B of retrieving data of a knowledge base of image types according to some embodiments of the present disclosure. The processes 1300A and 1300B of retrieving data of the knowledge base of the image type may be performed on the application management platform 110 as described before. In this example, it is assumed that the image type of the knowledge base created is a knowledge base. The processes 1300A and 1300B are described below with reference to FIG. 1.

As shown in FIG. 13A, at block 1305, the application management platform 110 may receive a request from the digital assistant (which may also be another application such as a workflow) to associate the image type knowledge base, associating the digital assistant with the image type knowledge base.

At block 1310, the application management platform 110 may receive the query information input by the user with a digital assistant.

At block 1315, the application management platform 110 may calculate a similarity between the query information and the labeling information of the image in the knowledge base 120 based on the query information and the labeling information of the image in the knowledge base 120 and match the image in the knowledge base 120 based on the calculated similarity. Since both the query information and the labeling information are in the table of text, the labeling information matching the query information may also be found by a semantic search, full-text search, or a hybrid search strategy in the labeling information of the images in accordance with the knowledge base approach of document types.

At block 1320, the application management platform 110 may recall the first predetermined number of images whose similarity satisfies a predetermined threshold and the labeling information corresponding to the images as the recalled content.

At block 1325, the application management platform 110 may merge the recall content (including the images and the labeling information corresponding to the images) with the query information as a query result output to the digital assistant. As an example, the process of generating the query result based on the recall content and the query information may be implemented by an LLM (Large Language Model).

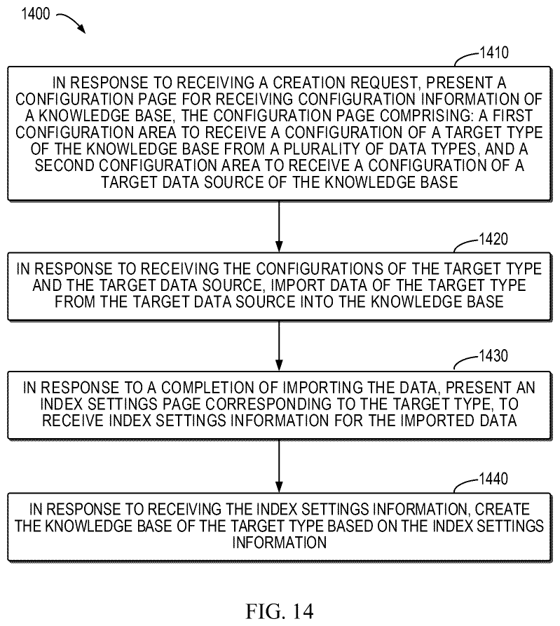

FIG. 14 illustrates a flowchart of an example process 1400 of information processing according to some embodiments of the present disclosure. The process 1400 may be implemented on the application management platform 110. The process 1400 is described below with reference to FIG. 1.

As shown, at block 1410, the application management platform 110, in response to receiving a creation request, presents a configuration page for receiving configuration information of a knowledge base, the configuration page including: a first configuration area to receive a configuration of a target type of the knowledge base from a plurality of data types, and a second configuration area to receive a configuration of a target data source of the knowledge base.

At block 1420, the application management platform 110, in response to receiving the configurations of the target type and the target data source, imports data of the target type from the target data source into the knowledge base.

At block 1430, the application management platform 110, in response to completing the import of the data, presents an index settings page corresponding to the target type to receive index settings information for the imported data.

At block 1440, the application management platform 110, in response to receiving the index settings information, creates the knowledge base of the target type based on the index settings information.

In some embodiments, the second configuration area presents at least one type of supported data source, the at least one type of data source including at least one of the following: a local data source, an online data source, a database, or custom data.

In some embodiments, importing data of the target type from the target data source into the knowledge base includes: in response to the target data source being a type of the custom data, presenting a data input area; and importing input data received in the data input area into the knowledge base.

In some embodiments, the target type includes a document type, and wherein presenting an index settings page corresponding to the target type includes: presenting an index settings page corresponding to the document type to receive segment index settings for a document, the segment index settings indicating at least one of: a segment rule, a segment length, or a segment preprocessing rule for a document, a segment of a document corresponding to a data item for indexing. In some embodiments, the target type includes a table type, and wherein presenting an index settings page corresponding to the target type includes: presenting an index settings page corresponding to the table type to receive table header index settings for a table, the table header index settings indicating a table header field to index a data item in the table. In some embodiments, the target type includes an image type, and wherein presenting an index settings page corresponding to the target type includes: presenting an index settings page corresponding to the image type to receive labeling settings for an image, the labeling settings indicating a text label to index an image.

In some embodiments, the target type includes a document type, and an index settings page corresponding to the document type includes default segment index settings and an input entrance for user-defined segment index settings. In some embodiments, the target type includes an image type, and an index settings page corresponding to the image type includes an automatic generation entrance for labeling settings and an input entrance for user-defined labeling settings.

In some embodiments, the process 1400 further includes: in response to a view request for a knowledge base list, presenting a knowledge base list page including a plurality of class view entrances corresponding to each of the plurality of data types; and in response to a selection of a class view entrance corresponding to a first data type among the plurality of data types, presenting a created knowledge base of the first data type.

In some embodiments, the process 1400 further includes: in response to a detail view request for the knowledge base, presenting a detail page of the knowledge base, the detail page including an aggregated display of a plurality of processed data items, and further including at least one of: metadata of the knowledge base, a list of files imported into the knowledge base, index settings information corresponding to the knowledge base, a number of data items, an addition entrance for new data, a trigger entrance for re-indexing, or a settings entrance for update frequency.

In some embodiments, the process 1400 further includes: in response to a trigger operation on a first data item in the detail page, presenting an edit option or a delete option for the first data item; in response to a selection of the edit option, receiving an editing input for the first data item in an edit mode of the first data item; and in response to a selection of the delete option, deleting the first data item from the knowledge base.

In some embodiments, the process 1400 further includes: in response to a selection of a target file in the list of files, presenting, in the detail page, an aggregated display of data items obtained by processing the target file.

In some embodiments, the process 1400 further includes: receiving a modification request for the knowledge base, the modification request indicating at least one of: a modification of metadata of the knowledge base, a modification of index settings information of the knowledge base, or an addition of data to the knowledge base.

In some embodiments, the target type of the knowledge base is an image type, and wherein presenting a detail page of the knowledge base includes: presenting, in the detail page, a list of images imported into the knowledge base and a text label corresponding to each of one or more images.

In some embodiments, the process 1400 further includes: presenting a target image in response to a detail view request for the target image in the knowledge base. Alternatively, or in addition, in some embodiments, the process 1400 further includes: in response to receiving a trigger operation for automatic labeling generation, generating a target text label corresponding to the target image with an automatic label generation tool. Alternatively, or in addition, in some embodiments, the process 1400 further includes: in response to an absence of a corresponding text label for the target image, presenting the target text label in a label display area corresponding to the target image. Alternatively, or in addition, in some embodiments, the process 1400 further includes: in response to an existence of a corresponding previous text label for the target image, replacing the previous text label with the target text label in the label display area corresponding to the target image in accordance with a determination that a confirmation is received from a user.

In some embodiments, the process 1400 further includes: presenting, in a creation page of a target application or a target workflow, a knowledge base selection area indicating the plurality of data types; in response to a selection of the target type among the plurality of data types, presenting, in the knowledge base selection area, at least the knowledge base corresponding to the target type; and in response to a selection of the knowledge base being received, associating the knowledge base with the target application or the target workflow.

In some embodiments, the process 1400 further includes: in response to the knowledge base being associated with the target application or the target workflow, causing, based on query information to the target application or the target workflow, the knowledge base to be invoked to determine processing of the query information.

In some embodiments, creating the knowledge base of the target type includes: processing the imported data of the target type based on the index settings information, the created knowledge base including a plurality of data items indexable after the processing.

In some embodiments, for the data of the target type, the plurality of data items are stored in each of a plurality of types of index libraries and the plurality of data items are each indexed by a plurality of types of data indexes. The process 1400 further includes: in response to receiving a query for the knowledge base, searching, based on a search algorithm corresponding to each of the plurality of types of index libraries, for a plurality of sets of data items that match the query from the plurality of types of index libraries, respectively; and selecting, based on a sorting result of the plurality of sets of data items, at least one data item from the plurality of sets of data items as a response to the query.

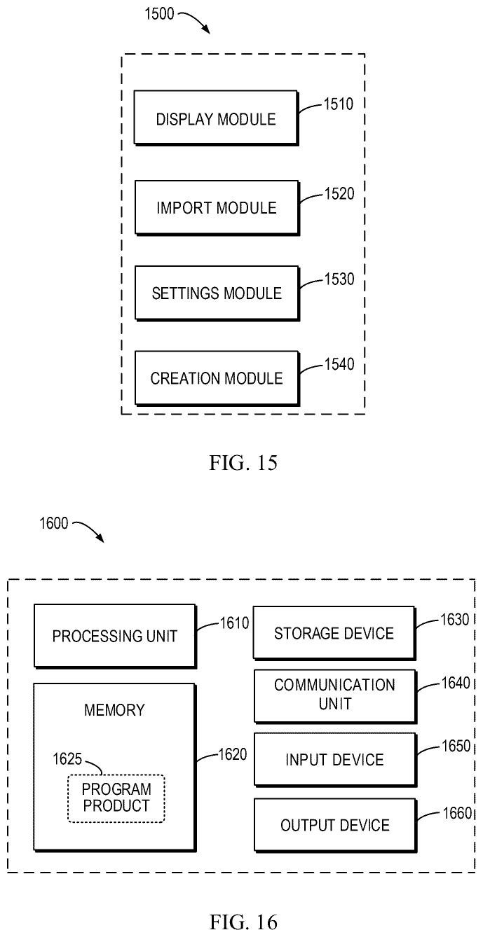

An embodiment of the present disclosure also provides a corresponding apparatus for implementing the above methods or processes. FIG. 15 illustrates a schematic structural block diagram of an example apparatus 1500 for information processing according to certain embodiments of the present disclosure. The apparatus 1500 may be implemented or included in the electronic device 110. Various modules/components in the apparatus 1500 may be implemented by hardware, software, firmware, or any combination thereof.

As shown in FIG. 15, the apparatus 1500 includes: a display module 1510 configured to, in response to receiving a creation request, present a configuration page for receiving configuration information of a knowledge base, the configuration page including: a first configuration area to receive a configuration of a target type of the knowledge base from a plurality of data types, and a second configuration area to receive a configuration of a target data source of the knowledge base; an import module 1520 configured to, in response to receiving the configurations of the target type and the target data source, import data of the target type from the target data source into the knowledge base; a settings module 1530 configured to, in response to completing the importing the data, present an index settings page corresponding to the target type, to receive index settings information for the imported data; and a creation module 1540 configured to, in response to receiving the index settings information, create the knowledge base of the target type based on the index settings information.

In some embodiments, the second configuration area presents at least one type of supported data source, the at least one type of data source including at least one of the following: a local data source, an online data source, a database, or custom data.

In some embodiments, the import module 1520 is further configured to: in response to the target data source being a type of the custom data, present a data input area; and import input data received in the data input area into the knowledge base.

In some embodiments, the target type includes a document type, and the display module 1510 is configured to present an index settings page corresponding to the target type includes: presenting an index settings page corresponding to the document type to receive segment index settings for a document, the segment index settings indicating at least one of the following: a segment rule, a segment length, or a segment preprocessing rule for a document, a segment of a document corresponding to a data item for indexing. In some embodiments, the target type includes a table type, and the display module 1510 is configured to present an index settings page corresponding to the target type includes: presenting an index settings page corresponding to the table type to receive table header index settings for a table, the table header index settings indicating a table header field to index a data item in the table. In some embodiments, the target type includes an image type, and the display module 1510 is configured to present an index settings page corresponding to the target type includes: presenting an index settings page corresponding to the image type to receive labeling settings for an image, the labeling settings indicating a text label to index an image.

In some embodiments, the target type includes a document type, and an index settings page corresponding to the document type includes default segment index settings and an input entrance for user-defined segment index settings. In some embodiments, the target type includes an image type, and an index settings page corresponding to the image type includes an automatic generation entrance for labeling settings and an input entrance for user-defined labeling settings.

In some embodiments, the apparatus 1500 further includes a list display module configured to, in response to a view request for a knowledge base list, present a knowledge base list page including a plurality of class view entrances corresponding to each of the plurality of data types; and a knowledge base view module configured to, in response to a selection of a class view entrance corresponding to a first data type among the plurality of data types, present a created knowledge base of the first data type.

In some embodiments, the apparatus 1500 further includes: a detail display module configured to, in response to a detail view request for the knowledge base, present a detail page of the knowledge base, the detail page including an aggregated display of a plurality of processed data items, and further including at least one of the following: metadata of the knowledge base, a list of files imported into the knowledge base, index settings information corresponding to the knowledge base, the number of data items, an addition entrance for new data, a trigger entrance for re-indexing, or a settings entrance for update frequency.

In some embodiments, the apparatus 1500 further includes: an option display module configured to, in response to a trigger operation on a first data item in the detail page, present an edit option or a delete option for the first data item; and an edit receiving module configured to, in response to a selection of the edit option, receive an editing input for the first data item in an edit mode of the first data item; and a data item deletion module configured to, in response to a selection of the delete option, delete the first data item from the knowledge base.

In some embodiments, the apparatus 1500 further includes: an aggregation display module configured to, in response to a selection of a target file in the list of files, present, in the detail page, an aggregated display of data items obtained by processing the target file.

In some embodiments, the apparatus 1500 further includes: a modification request receiving module configured to receive a modification request for the knowledge base, the modification request indicating at least one of the following: a modification of metadata of the knowledge base, a modification of index settings information of the knowledge base, or an addition of data to the knowledge base.

In some embodiments, the target type of the knowledge base is an image type, and the display module 1510 is further configured to present, in the detail page, a list of images imported into the knowledge base and a text label corresponding to each of one or more images.

In some embodiments, the apparatus 1500 further includes: an image display module configured to present a target image in response to a detail view request for the target image in the knowledge base; an label generation module configured to, in response to receiving a trigger operation for automatic labeling generation, generate a target text label corresponding to the target image with an automatic label generation tool; an label display module configured to, in response to an absence of a corresponding text label for the target image, present the target text label in a label display area corresponding to the target image; and an label replacement module configured to, in response to an existence of a corresponding previous text label for the target image, replace the previous text label with the target text label in the label display area corresponding to the target image in accordance with a determination that a confirmation is received from a user.

In some embodiments, the apparatus 1500 further includes: a knowledge base selection module configured to present, in a creation page of a target application or a target workflow, a knowledge base selection area indicating the plurality of data types; a type selection module configured to, in response to a selection of the target type among the plurality of data types, present, in the knowledge base selection area, at least the knowledge base corresponding to the target type; and a knowledge base association module configured to, in response to a selection of the knowledge base being received, associate the knowledge base with the target application or the target workflow.

In some embodiments, the apparatus 1500 further includes an invocating module configured to: in response to the knowledge base being associated with the target application or the target workflow, cause, based on query information to the target application or the target workflow, the knowledge base to be invoked to determine processing of the query information.

In some embodiments, the creation module 1540 is further configured to process the imported data of the target type based on the index settings information, the created knowledge base including a plurality of data items indexable after the processing.

In some embodiments, for the data of the target type, the plurality of data items are stored in each of a plurality of types of index libraries and the plurality of data items are each indexed by a plurality of types of data indexes. The apparatus 1500 further includes: a search module configured to, in response to receiving a query for the knowledge base, searching, based on a search algorithm corresponding to each of the plurality of types of index libraries, for a plurality of sets of data items that match the query from the plurality of types of index libraries, respectively; and a data item selection module configured to select, based on a sorting result of the plurality of sets of data items, at least one data item from the plurality of sets of data items as a response to the query.

FIG. 16 illustrates a block diagram of an electronic device 1600 in which one or more embodiments of the present disclosure can be implemented. It should be understood that the electronic device 1600 shown in FIG. 16 is only illustrative and should not constitute any limitation on the functionality and scope of the embodiments described herein. The electronic device 1600 shown in FIG. 16 may be used to implement the application management platform 110 of FIG. 1.

As shown in FIG. 16, the electronic device 1600 is in the table of a general electronic device. The components of the electronic device 1600 may include, but are not limited to, one or more processors or processing units 1610, a memory 1620, a storage device 1630, one or more communication units 1640, one or more input devices 1650, and one or more output devices 1660. The processing units 1610 may be actual or virtual processors and can execute various processes according to the programs stored in the memory 1620. In a multiprocessor system, multiple processing units execute computer executable instructions in parallel to improve the parallel processing capability of the electronic device 1600.

The electronic device 1600 typically includes a variety of computer storage media. Such media can be any available media that is accessible to the electronic device 1600, including but not limited to volatile and non-volatile media, removable and non-removable media. The memory 1620 can be volatile memory (such as registers, caches, random access memory (RAM)), nonvolatile memory (such as a read-only memory (ROM), an electrically erasable programmable read-only memory (EEPROM), a flash memory), or some combination thereof. The storage device 1630 can be any removable or non-removable medium, and can include machine-readable medium, such as a flash drive, a disk, or any other medium which can store information and/or data and can be accessed within the electronic device 1600.

The electronic device 1600 may further include additional removable/non-removable, volatile/non-volatile storage medium. Although not shown in FIG. 16, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 1620 can include a computer program product 1625, which includes one or more program modules configured to execute various methods or actions of the various embodiments disclosed in this specification.

The communication unit 1640 implements communication with other electronic devices via a communication medium. In addition, functions of components in the electronic device 1600 may be implemented by a single computing cluster or multiple computing machines, which can communicate through a communication connection. Therefore, the electronic device 1600 may be operated in a networking environment using a logical connection with one or more other servers, a network personal computer (PC), or another network node.

The input device 1650 may be one or more input devices, such as a mouse, a keyboard, a trackball, etc. The output device 1660 may be one or more output devices, such as a display, a speaker, a printer, etc. The electronic device 1600 may also communicate with one or more external devices (not shown) through the communication unit 1640 as required. The external device, such as a storage device, a display device, etc., communicate with one or more devices that enable users to interact with the electronic device 1600, or communicate with any device (for example, a network card, a modem, etc.) that makes the electronic device 1600 communicate with one or more other computing devices. Such communication may be executed via an input/output (I/O) interface (not shown).

According to example implementation of the present disclosure, there is provided a computer-readable storage medium on which a computer-executable instruction or computer program is stored, wherein the computer-executable instructions are executed by a processor to implement the methods described above. According to example embodiments of the present disclosure, a computer program product is provided which is tangibly stored in a computer storage medium and includes computer-executable instructions, the computer-executable instructions, when executed by a device, cause the device to perform the methods described above.

Various aspects of the present disclosure are described in this specification with reference to the flow chart and/or the block diagram of the method, the device, the apparatus and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be executed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description provides examples, not exhaustive, and is not limited to the disclosed implementations. Without departing from the scope and spirit of the described implementations, many modifications and changes are obvious to those of ordinary skill in the art. The selection of terms used in this article aims to best explain the principles, practical application or improvement of technology in the market of each implementation, or to enable others of ordinary skill in the art to understand the various embodiments disclosed in this specification.

1. A method of information processing, comprising:
in response to receiving a creation request, presenting a configuration page for receiving configuration information of a knowledge base, the configuration page comprising:
a first configuration area to receive a configuration of a target type of the knowledge base from a plurality of data types, and
a second configuration area to receive a configuration of a target data source of the knowledge base;
in response to receiving the configurations of the target type and the target data source, importing data of the target type from the target data source into the knowledge base;
in response to completing the importing the data, presenting an index settings page corresponding to the target type to receive index settings information for the imported data; and
in response to receiving the index settings information, creating the knowledge base of the target type based on the index settings information.

2. The method of claim 1, wherein the second configuration area presents at least one type of supported data source, the at least one type of supported data source comprising at least one of: a local data source, an online data source, a database, or custom data.

3. The method of claim 2, wherein importing data of the target type from the target data source into the knowledge base comprises:
in response to the target data source having a type of the custom data, presenting a data input area; and
importing input data received in the data input area into the knowledge base.

4. The method of claim 1, wherein the target type comprises a document type, and wherein presenting an index settings page corresponding to the target type comprises: presenting an index settings page corresponding to the document type to receive segment index settings for a document, the segment index settings indicating at least one of: a segment rule, a segment length, or a segment preprocessing rule for a document, a segment of a document corresponding to a data item for indexing; or,
wherein the target type comprises a table type, and wherein presenting an index settings page corresponding to the target type comprises: presenting an index settings page corresponding to the table type to receive table header index settings for a table, the table header index settings indicating a table header field to index a data item in the table; or
wherein the target type comprises an image type, and wherein presenting an index settings page corresponding to the target type comprises: presenting an index settings page corresponding to the image type to receive labeling settings for an image, the labeling settings indicating a text label to index an image.

5. The method of claim 1, wherein the target type comprises a document type, and an index settings page corresponding to the document type comprises default segment index settings and an input entrance for user-defined segment index settings; or
wherein the target type comprises an image type, and an index settings page corresponding to the image type comprises an automatic generation entrance for labeling settings and an input entrance for user-defined labeling settings.

6. The method of claim 1, further comprising:
in response to a view request for a knowledge base list, presenting a knowledge base list page comprising a plurality of class view entrances corresponding to each of the plurality of data types; and
in response to a selection of a class view entrance corresponding to a first data type among the plurality of data types, presenting a created knowledge base of the first data type.

7. The method of claim 1, further comprising:
in response to a detail view request for the knowledge base, presenting a detail page of the knowledge base, the detail page comprising an aggregated display of a plurality of processed data items, and further comprising at least one of:
metadata of the knowledge base,
a list of files imported into the knowledge base,
index settings information corresponding to the knowledge base,
a number of data items,
an addition entrance for new data,
a trigger entrance for re-indexing, or
a settings entrance for update frequency.

8. The method of claim 7, further comprising:
in response to a trigger operation on a first data item in the detail page, presenting an edit option or a delete option for the first data item;
in response to a selection of the edit option, receiving an editing input for the first data item in an edit mode of the first data item; and
in response to a selection of the delete option, deleting the first data item from the knowledge base.

9. The method of claim 7, further comprising:
in response to a selection of a target file in the list of files, presenting, in the detail page, an aggregated display of data items obtained by processing the target file.

10. The method of claim 1, further comprising:
receiving a modification request for the knowledge base, the modification request indicating at least one of:
a modification of metadata of the knowledge base,
a modification of index settings information of the knowledge base, or
an addition of data to the knowledge base.

11. The method of claim 7, wherein the target type of the knowledge base is an image type, and wherein presenting a detail page of the knowledge base comprises:
presenting, in the detail page, a list of images imported into the knowledge base and a text label corresponding to each of one or more images.

12. The method of claim 11, further comprising performing at least one of:
presenting a target image in response to a detail view request for the target image in the knowledge base;
in response to receiving a trigger operation for automatic labeling generation, generating a target text label corresponding to the target image with an automatic label generation tool;
in response to an absence of a corresponding text label for the target image, presenting the target text label in a label display area corresponding to the target image; or
in response to an existence of a corresponding previous text label for the target image, replacing the previous text label with the target text label in the label display area corresponding to the target image in accordance with a determination that a confirmation is received from a user.

13. The method of claim 1, further comprising:
presenting, in a creation page of a target application or a target workflow, a knowledge base selection area indicating the plurality of data types;
in response to a selection of the target type among the plurality of data types, presenting, in the knowledge base selection area, at least the knowledge base corresponding to the target type; and
in response to a selection of the knowledge base being received, associating the knowledge base with the target application or the target workflow.

14. The method of claim 13, further comprising:
in response to the knowledge base being associated with the target application or the target workflow, causing, based on query information to the target application or the target workflow, the knowledge base to be invoked to determine processing of the query information.

15. The method of claim 1, wherein creating the knowledge base of the target type comprises:
processing the imported data of the target type based on the index settings information, the created knowledge base comprising a plurality of data items indexable after the processing.

16. The method of claim 15, wherein for the data of the target type, the plurality of data items are stored in each of a plurality of types of index libraries and the plurality of data items are each indexed by a plurality of types of data indexes, the method further comprising:
in response to receiving a query for the knowledge base, searching, based on a search algorithm corresponding to each of the plurality of types of index libraries, for a plurality of sets of data items that match the query from the plurality of types of index libraries, respectively; and
selecting, based on a sorting result of the plurality of sets of data items, at least one data item from the plurality of sets of data items as a response to the query.

17. An electronic device, comprising:
at least one processing unit; and
at least one memory coupled to the at least one processing unit and storing instructions for execution by the at least one processing unit, the instructions, when executed by the at least one processing unit, causing the electronic device to perform operations comprising:
in response to receiving a creation request, presenting a configuration page for receiving configuration information of a knowledge base, the configuration page comprising:
a first configuration area to receive a configuration of a target type of the knowledge base from a plurality of data types, and
a second configuration area to receive a configuration of a target data source of the knowledge base;
in response to receiving the configurations of the target type and the target data source, importing data of the target type from the target data source into the knowledge base;
in response to completing the importing the data, presenting an index settings page corresponding to the target type to receive index settings information for the imported data; and
in response to receiving the index settings information, creating the knowledge base of the target type based on the index settings information.

18. The electronic device of claim 17, wherein the second configuration area presents at least one type of supported data source, the at least one type of supported data source comprising at least one of: a local data source, an online data source, a database, or custom data.

19. The electronic device of claim 18, wherein importing data of the target type from the target data source into the knowledge base comprises:
in response to the target data source having a type of the custom data, presenting a data input area; and
importing input data received in the data input area into the knowledge base.

20. A non-transitory computer-readable storage medium having a computer program stored thereon, the computer program being executable by a processor to perform operations comprising:
in response to receiving a creation request, presenting a configuration page for receiving configuration information of a knowledge base, the configuration page comprising:
a first configuration area to receive a configuration of a target type of the knowledge base from a plurality of data types, and
a second configuration area to receive a configuration of a target data source of the knowledge base;
in response to receiving the configurations of the target type and the target data source, importing data of the target type from the target data source into the knowledge base;
in response to completing the importing the data, presenting an index settings page corresponding to the target type to receive index settings information for the imported data; and
in response to receiving the index settings information, creating the knowledge base of the target type based on the index settings information.
